(19) United States
(12) Patent Application Publication
(10) Pub. No.: US 2005/0063575 A1
(43) Pub. Date: Mar. 24, 2005

(54) SYSTEM AND METHOD FOR ENABLING A SOFTWARE DEVELOPER TO INTRODUCE INFORMATIONAL ATTRIBUTES FOR SELECTIVE INCLUSION WITHIN IMAGE HEADERS FOR MEDICAL IMAGING APPARATUS APPLICATIONS

(75) Inventors: Qiang Ma, Bayside, WI (US); Robert H. Haworth, Brookfield, WI (US)

Correspondence Address: ARTZ & ARTZ, P.C., 28333 TELEGRAPH RD., SUITE 250, SOUTHFIELD, MI, 48034, US

(73) Assignee: GE MEDICAL SYSTEMS GLOBAL TECHNOLOGY, LLC, Waukesha, WI (US)

(21) Appl. No.: 10/605,317

(22) Filed: Sep. 22, 2003

(51) Int. Cl. G06K 9/00; G06K 9/36

(52) U.S. Cl. 382/128; 382/276

(57) ABSTRACT

A system and method for enabling a developer to introduce informational attributes suitable for selective inclusion within image headers is disclosed herein. The image headers, along with their selectively included informational attributes, are displayable on a monitor screen together with associated digital images produced by an imaging apparatus. The image headers are also selectively storable in a database together with the pixel data of the associated digital images. The system includes an interactive workstation computer system having memory-stored software applications for operating the imaging apparatus, a memory-stored updatable table of defined informational attributes suited for selective inclusion within image headers, an interactive computer for generating software files of image header definitions from the table of defined informational attributes, and a means to transport the software files of image header definitions to the interactive workstation computer system.

### BACKGROUND OF INVENTION

The present invention generally relates to an operator-interactive computer system interfaced with a medical imaging apparatus. The medical imaging apparatus is particularly capable of scanning a patient and thereafter producing a digital image of a region of interest (ROI) within the patient. The operator-interactive computer system is particularly capable of enabling an operator to operate the medical imaging apparatus and thereby capture, display, and selectively archive each digital image for medical diagnosis or clinical research purposes.

In a modern hospital setting, medical imaging apparatus systems situated therein are commonly networked to a central image management system, such as a “picture archival and communications system” (PACS). The medical imaging apparatuses themselves commonly utilize, for example, electromagnetic radiation, x-rays, sonic waves, or photonic energy to produce viewable digital images of internal regions within a subject of interest, such as a patient. Once produced, the digital images may then be utilized by a medical professional to aid in the examination, diagnosis, and treatment of the patient. Frequently, one particular type of medical imaging apparatus is preferable over another type of apparatus for producing digital images of a certain region of interest (ROI) within a patient. For example, ultrasound imaging apparatuses are particularly useful for producing digital images that enable one to view a fetus and accordingly administer prenatal care to a patient going through a pregnancy. Magnetic resonance (MR) imaging apparatuses, on the other hand, are particularly useful for producing digital images of a wide range of tissues within a patient and are therefore ideal for detecting cancer.

The central image management system typically includes a central storage unit that is coupled to a plurality of operator-interactive workstations or terminals frequently referred to as “PACS workstations.” The central storage unit itself is particularly configured to store or archive digital images produced by any medical imaging apparatus systems networked thereto. In addition, the central storage unit is also particularly configured to allow the selective retrieval of digital images therefrom for display and viewing on any of the workstations networked to or within the central image management system. In this way, if a hospital has a large number of medical imaging apparatuses situated throughout the hospital, digital images produced by any one or more of the medical imaging apparatus systems can be selectively stored or archived in the central storage unit and then later selectively retrieved and viewed by any one or more of the physicians or other medical professionals working throughout the hospital at any one or more of the workstations.

When a physician or other medical professional as an operator conducts work on a workstation, the operator is able to selectively retrieve and view digital images from one or more sets of archived images produced during one or more prior examinations of a particular patient. In addition to viewing digital images, other information such as medical imaging apparatus identification, imaging parameters, presiding physician identification, and identifying information associated with the patient himself are all accessible and viewable as well. Once an operator selects and successfully displays a digital image on the monitor screen of a workstation, the operator is then able to manipulate the image such as by zooming in on a portion of the image or by changing the viewing order of the image within a set of images. The operator can also selectively move and store sets of images in different categories of computer work files such as, for example, priority review examination work files, not-yet-reviewed examination work files, recently reviewed examination work files, et cetera. In order to facilitate an operator's successful and expedited navigation through and between digital image sets and computer work files, the workstation includes a user-friendly graphical user interface (GUI) on the screen of its monitor. The graphical user interface is typically designed such that an operator can specify his on-screen viewing preferences relating to the visual layout of the on-screen icons displayed by the graphical user interface.

Although there are numerous different types of medical imaging apparatuses, some of the more prevalent types include a computerized tomography (CT) imaging apparatus, a magnetic resonance (MR) imaging apparatus, an ultrasound imaging apparatus, and an x-ray imaging apparatus. As alluded to earlier hereinabove, although each type of medical imaging apparatus functions and operates in a manner different from the other types, all types generally operate to focus in on regions of interest (ROI) within patients and produce digital images of those regions. In this way, once the digital images are produced, the digital images may then be utilized by medical professionals to aid in the examination, diagnosis, and treatment of patients.

As an example, conventional ultrasound imaging apparatuses function and operate to primarily create two-dimensional images of biological tissue. Such is accomplished first by scanning a focused ultrasound beam in a scan plane and thereafter detecting, for each transmitted beam, the ultrasound wave energy returned along a respective scan line in the scan plane. A single scan line, or a small localized group of scan lines, is acquired by first transmitting focused ultrasound energy at a particular point and then receiving the reflected energy over time. The focused transmit energy is referred to as a “transmit beam.” During the time period after transmit, one or more receive beamformers coherently sum up the energy received by each channel with dynamically changing phase rotation or delays. In this way, peak sensitivity produced along the desired scan lines at ranges proportional to the elapsed time after transmit can be observed. Such a resulting focused sensitivity pattern is referred to as a “receive beam.” In general, a scan line's resolution is a result of the directivity of the associated transmit beam and receive beam pair.

A B-mode ultrasound image is composed of multiple image scan lines. The displayed brightness of a pixel on a monitor screen associated with an ultrasound imaging apparatus system is based on the intensity of the echo returned from the biological tissue being scanned. The outputs of the receive beamformer channels are coherently summed up to form a respective pixel intensity value for each sample volume in the object region or volume of interest. These pixel intensity values are log-compressed, scan-converted, and then displayed as an H-mode image of a scanned region of a patient's anatomy.

If the transducer probe of an ultrasound imaging apparatus is swept over an area of a patient's body during examination, a resultant succession of image frames that correspond to spaced slices intersecting the body are thereby displayed on the ultrasound imaging apparatus system's monitor screen. In one type of ultrasound imaging apparatus system, a long sequence of the most recent images are stored and continuously updated automatically in an associated cine memory on a first-in, first-out basis. The cine memory, in general, operates as a circular image buffer that runs unnoticeably in the background, capturing pixel data of images that are successively displayed on the monitor screen in real time for an operator to view. In addition, the cine memory also operates as a buffer for the transfer of images to a digitally-based image archive or database via an operator-interactive workstation computer system directly interfaced with the ultrasound imaging apparatus. Given such a configuration, when an operator opts to freeze or pause operation of the ultrasound imaging apparatus via the operator-interactive workstation computer system, the operator may then selectively view the images that were captured in the cine memory during operation of the ultrasound imaging apparatus. In particular, individual images within the loop of successive images stored in the cine memory can be selectively pulled up for display on the monitor screen via a trackball pointing device associated with the workstation computer system, then viewed by the operator, and thereafter selectively stored on the workstation computer system's hard disk or in a remote image archive or database networked thereto.

If the transducer probe of the ultrasound imaging apparatus was moving during image acquisition while the ultrasound imaging apparatus was operating, the resultant succession of image frames captured and stored in the cine memory together form a three-dimensional data volume of image information. This data volume can be used by the workstation computer system to construct a three-dimensional image of an internal region of interest associated with the patient. Once constructed, the three-dimensional image can then be selectively stored in the cine memory and then displayed on the monitor screen as a viewable image. In addition, the constructed three-dimensional image may also be selectively stored, for example, on the hard disk within the workstation computer system, on a magneto-optical disk (MOD) inserted in a disk drive within the workstation computer system, or in a remote image archive or database networked to the workstation computer system.

Thus, in addition to merely storing images internally on a hard drive or on an insertable disk, ultrasound imaging apparatus systems should preferably be able to transfer images to remote operator-interactive workstations, remote archives, remote databases, or other remote destination devices via a communications network. To successfully transfer images, the relevant networking features of an ultrasound imaging apparatus system must be compatible with the networking features of the remote destination device. In particular, the ultrasound imaging apparatus system must be able to convert, as necessary, image pixel data into a format that can be readily transferred, received, and handled by the remote destination device. In an attempt to ensure such successful transfers of image pixel data to remote destination devices, DICOM (Digital Imaging and Communications in Medicine) standards have been widely adopted by professionals in the medical imaging community. In general, DICOM standards serve to establish and specify technical conformance requirements for relevant networking features in medical imaging apparatuses, operator-interactive workstation computer systems, archives and databases, and other devices connected to a common network. In particular, the DICOM standards, when properly implemented, serve to facilitate the trouble-free transfer and communication of images, in digital pixel data form, between and among operator-interactive workstation computer systems, image data acquisition modules associated with various medical imaging apparatuses, file servers, printers, and archives or databases that are connected to a network. Thus, each operator-interactive workstation computer system and acquisition module associated with a given medical imaging apparatus is programmed to transfer image data in a format that complies with the DICOM standards while each remote destination device to receive such data is similarly programmed to receive data that has been formatted in compliance with those same DICOM standards.

DICOM standards relate to more than just the digital transfer of image pixel data. In particular, DICOM standards also relate to functionality in areas that include the following “service classes”: archive/transfer images store across network; archive/interchange images media storage; query for information and retrieve images; make image hard copies print management; patient, study, and results management; radiology information system modality—worklist management; and test connectivity—verification. A fundamental concept implemented by or employed in DICOM standards is—services on objects,—that is, performing a particular operation (service) on a particular piece of information (object). One example of an “object” is an image produced by an ultrasound imaging apparatus. Two examples of a “service” are the “store” and “query/retrieve” functions. Per DICOM standards, methods of operating on information objects are referred to as “service object pair classes” or simply “SOP classes.” Examples of SOP classes according to DICOM standards include, for example, “store an ultrasound image”, “print an ultrasound image”, “find any existing studies on a certain patient,” “retrieve all studies on a certain patient,” and “retrieve a worklist.” Furthermore, in DICOM, “unique identifiers” (UIDs) are defined for all SOP classes. In addition, UIDs are also assigned to all patient studies, image series, and individual images. These UIDs are particularly useful, for example, for the selective retrieval of any of such patient studies, image series, and individual images that are stored in a memory. Thus, according to DICOM vernacular, a patient “has” an associated study that “includes” one or more study “components” such as, for example, a patient examination wherein a particular modality (i.e., computerized tomography, magnetic resonance, ultrasound, or x-ray) was utilized to generate images. Such images generated and acquired in sequence during the course of the examination or study on the patient together form a successive series of individual information objects which are selectively retrievable.

The DICOM standards system is largely based upon a client/server concept. For example, a network-connected device that chooses a service for use on particular information objects is considered to be a client device while another network-connected device that actually provides the service is considered to be the server device. The client device, according to DICOM nomenclature, is referred to as a “service class user” (SCU) while the server device is referred to as a “service class provider” (SCP). In operation, the SCU sends a “service request” to the SCP over a network such as, for example, a local area network (LAN). The SCP sends back a response to the SCU over the same local area network. If the response is affirmative and a communications syntax is thereby agreed upon by the two devices, an open association between the SCU and the SCP is then cooperatively created so that data can then be transferred between the two devices. In the DICOM standards system, a given network-connected device is not relegated to having only one role. Instead, a given device can take on the role of being either a SCU or a SCP, though the device generally cannot take on both roles simultaneously.

In general, the DICOM standards system is designed to facilitate the transfer and communication of digital images of various different types. That is, the DICOM standards system is designed to facilitate the transfer of digital images between devices connected to a network whether the images were originally produced by a computerized tomography (CT) imaging apparatus, a magnetic resonance (MR) imaging apparatus, an ultrasound imaging apparatus, or even an x-ray imaging apparatus. For example, on an ultrasound imaging apparatus system having conventional DICOM capability, three operations including “image send,” “image print,” and “remote verification” can be carried out across a network in cooperation with a remote DICOM-compatible device such as, for example, an operator-interactive workstation, an image archive or database, or a printer. Both the “image send” and the “image print” operations can be carried out in either an automatic or manual mode. “Remote verification,” that is, verification that a remote receiving device networked to the ultrasound imaging apparatus system is both available and DICOM-compatible, is performed when the ultrasound imaging apparatus system is initially powered up or when specifically requested by an operator.

In general, all DICOM activities are handled in a queued manner by application software that is memory-stored and run on an operator-interactive workstation computer system which itself is directly interfaced and largely integrated with the ultrasound imaging apparatus. In addition to being interfaced with the ultrasound imaging apparatus, the workstation computer system is also typically connected to some network such as, for example, a local area network (LAN). Within such a configuration, an operator of the workstation computer system can run the application software on the workstation computer system to thereby operate and directly control the ultrasound imaging apparatus so that images of a patient under examination can be produced by the ultrasound imaging apparatus and thereafter captured within the cine memory associated with both the workstation computer system and the ultrasound imaging apparatus. In this way, an operator can select any image captured in the cine memory and thereafter send the image in DICOM format via the network to a remote destination device, such as an image archive or database, that is also DICOM-compatible. To accomplish such, the operator-interactive workstation computer system directly interfaced with the ultrasound imaging apparatus is specifically programmed with DICOM system software. Such DICOM system software facilitates the transmission of selected images to the remote DICOM-compatible destination device via both the workstation computer system's hard disk and the network.

In a conventional ultrasound imaging apparatus system configuration, an “image send” command issued from the operator-interactive workstation computer system can be prompted and initiated in either automatic or manual mode depending on configuration specifics. When configured for automatic mode, console keys associated with the workstation computer system are used by an operator to capture an image produced by the ultrasound imaging apparatus and to thereafter store the image on the workstation computer system's hard disk. In addition, any “image send” request by the operator is queued to a DICOM queue manager, preferably implemented in software, which requests an “association” with a remote destination device across the network. After an association with the remote destination device has been cooperatively opened, the queue manager then automatically “pushes” the image from the hard disk of the workstation computer system, across the network, and ultimately to the remote destination device without operator intervention. That is, the transfer is automatically done in the background while further operator-initiated scanning operations are permitted to continue on the ultrasound imaging apparatus. In contrast, when configured for manual mode, the images captured from the ultrasound imaging apparatus are first stored on the hard disk, or on a removable magneto-optical disc (MOD) drive, within the workstation computer system during patient examination. Then, upon completion of both the examination and scanning, the captured images can be selectively tagged by an operator using a software-driven archive menu on the workstation computer system and then queued to any one or more remote destination devices (for example, an image archive or database) on the network. Again, images are sent sequentially in the background while scanning or other operator-initiated operations are permitted to continue on the ultrasound imaging apparatus. Similar to the “image send” command, the “image print” command works in much the same way in both automatic and manual modes, except that the remote destination device to which images are transferred across the network is a printer instead of a workstation, image archive, or database.

In order to successfully accomplish the transfer of images across a network, an ultrasound imaging apparatus system must “know” the configuration of the remote destination device prior to attempting to communicate with and transfer images to that device. DICOM-compatible configuration data relating to the remote destination device is typically input into the ultrasound imaging apparatus system during software installation by a field engineer. In this way, when the ultrasound imaging apparatus system receives operator instruction from the workstation computer system to transmit image pixel data to the remote destination device, software on the ultrasound imaging apparatus system converts the image pixel data into DICOM format, as required by the remote destination device before transfer, based on the configuration data for that device memory-stored in the ultrasound imaging apparatus system. In addition, the ultrasound imaging apparatus system also sends a request over the network to the remote destination device to open up an association between the ultrasound imaging apparatus system and the remote destination device. If the remote destination device responds affirmatively, the ultrasound imaging apparatus system and the remote destination device then decide on which SOP class is to be used and which, either the remote destination device or the ultrasound imaging apparatus system, will act as the server and which will act as the client during image transfer. Furthermore, the ultrasound imaging apparatus system also selects an appropriate encoding syntax from those deemed acceptable by the remote destination device. Still further, other communication parameters are also negotiated between the ultrasound imaging apparatus system and the remote destination device.

After DICOM communications protocol has been settled and an association is opened, the workstation computer system and the ultrasound imaging apparatus cooperatively send a DICOM-formatted image file (i.e., an object) containing image pixel data to the remote destination device via the network. Such a transfer is specifically carried out in the background while operator-initiated scanning is permitted to simultaneously continue as desired. If the remote destination device is a storage device such as an image archive or database, each DICOM-formatted file of image pixel data is successively transferred, one at a time, in response to an operator-initiated “send” command dictated from the workstation computer system. In a conventional arrangement, an operator-interactive workstation computer system directly interfaced with an ultrasound imaging apparatus that is DICOM-compatible can together open up a separate association with a remote destination storage device in response to each operator-initiated “send” command dictated on the workstation computer system. Once the transfer of an image file of image pixel data across a network is successfully completed, the association between the ultrasound imaging apparatus system and the remote destination storage device for that transfer is then immediately closed. If, instead of an image archive or database, the remote destination device is a printer configured to print multi-image film, then a number of images are first accumulated to sufficiently fill up a piece of multi-image film. Thereafter, an association is opened up in response to an operator-initiated “send” command entered on the workstation computer system. When the number of accumulated images is eventually transmitted across the network, the association between the ultrasound imaging apparatus system and the multi-image film printer is thereafter closed. In closing any such association, if the remote destination device sends back a message indicating successful receipt of a transmitted image file with image pixel data, the DICOM-formatted image file can then be selectively deleted from the ultrasound imaging apparatus system's memory. As an alternative, the operator may instead instruct the ultrasound imaging apparatus system to retain the DICOM-formatted image file on the hard disk of the workstation computer system or to alternatively store it on a magneto-optical disc (MOD) inserted within a drive in the workstation computer system.

As alluded to hereinabove, the remote destination device to which an operator-interactive workstation computer system, working in conjunction with an ultrasound imaging apparatus, sends image files with image pixel data may be, for example, a printer, a storage device such as an image archive or database, or some other type of device. If the operator-interactive workstation computer system interfaced with the ultrasound imaging apparatus has only one configurable “print” or “store” button, then that button will be configured to initiate image pixel data transfer to the remote destination device across the network. Configuration data installed in the workstation computer system and/or the ultrasound imaging apparatus relating to a remote destination device will serve to inform the overall ultrasound imaging apparatus system as to the particular type of remote destination device with which communication is desired. Once informed in this manner, the workstation computer system in conjunction with the ultrasound imaging apparatus can then format image pixel data accordingly for successful transfer to the remote destination device. If the operator-interactive workstation computer system alternatively has multiple “print” and/or “store” buttons, then each button can be selectively configured to initiate the transfer of image pixel data to a different respective remote destination device. In this way, the transfer of image pixel data across the network to any one of the respectively configured remote destination devices can be initiated by an operator's simply pressing one of the “print” and/or “store” buttons.

In addition to the pixel data associated with a particular digital image, the image file or DICOM object cooperatively transferred from both the workstation computer system and the ultrasound imaging apparatus across a network to a remote destination device also includes informational attributes. Such informational attributes generally include information relating to the attributes of a patient being scanned for examination and also information relating to the attributes of various scan parameters or exam conditions. In particular, such informational attributes may include, for example, patient-specific information such as a patient's name, social security or identification number, sex, and/or birth date; study-specific information such as hospital name, accession number, and/or study date; series-specific information such as modality type, techniques used for acquisition, and/or series date; image-specific information such as image type with specified numbers of rows and columns; et cetera. In general, each informational attribute has a name, a tag, a value representation, and a value multiplicity. The tag is a number that is unique to a given informational attribute. The value representation defines what type of value the informational attribute can have, for example, a 64-character string, binary data, et cetera. The value multiplicity defines the number of values that can be included in the informational attribute.

According to DICOM standards, there are generally three types of informational attributes. Informational attributes which are “type 1” are mandatorily included in each image file and must each have an assigned or associated value. Informational attributes which are “type 2” are also mandatorily included in each image file but do not each have to include an assigned or associated value (i.e., can remain empty). Informational attributes which are “type 3” are optionally includable in each image file. In order to protect against the inadvertent loss of image pixel data and/or image attribute information produced and collected during the examination of a patient, image files containing such are typically stored, at least temporarily, on the hard disk of the operator-interactive workstation computer system. Thereafter, an operator may selectively or optionally delete the image files or transfer them across the network for retrievable storage in a remote archive or database.

Because DICOM standards and device capability are specifically implemented via software, operational features of an ultrasound imaging apparatus system can be easily enhanced by merely installing upgraded DICOM-compatible system software or application software. In this way, few to no hardware changes are necessary to upgrade the capabilities of an ultrasound imaging apparatus system. A primary goal of such software upgrades is to increase the efficiency of operators using both the workstation computer system and the ultrasound imaging apparatus. Such is accomplished through the software upgrades by making the overall ultrasound imaging apparatus system simpler to operate by, for example, reducing the number of operator manipulations necessary to carry out a particular operation on the workstation computer system. Another goal of such software upgrades is to increase the ability of the ultrasound imaging apparatus system to connect rapidly, efficiently, and reliably to remote destination devices on the network for the purpose of facilitating the trouble-free transfer of image files.

As alluded to earlier hereinabove, there are many different types of medical imaging apparatuses and systems in addition to an ultrasonic imaging apparatus system. In general, the primary distinction between the different imaging apparatuses and systems is the particular medical imaging modalities that are characteristically utilized thereby to scan patients. Such modalities may include, for example, computerized tomography (CT), magnetic resonance (MR), ultrasound, or x-ray. In addition to modalities, a broad range of modality-specific capabilities and features is typically available when utilizing a particular imaging modality. For example, a magnetic resonance imaging (MRI) apparatus directly interfaced with an operator-interactive workstation computer system can be made to have a wide range of polarizing magnetic strengths and configurations as well as a wide range of various different scanning capabilities such as magnetic resonance angiography (MRA), cardiac imaging, and functional magnetic resonance imaging (fMRI).

Despite their characteristic modality differences, conventional medical imaging apparatuses and systems have a significant number of basic features and/or functions in common. For example, all such medical imaging apparatuses and systems include an operator interface (such as an operator-interactive workstation computer system), an image acquisition apparatus (such as a computerized tomography imaging apparatus, a magnetic resonance imaging apparatus, an ultrasound imaging apparatus, or an x-ray imaging apparatus), an image reconstruction processor, and an image pixel data storage apparatus (such as a hard disk, an image archive, or a database). The operator interface, first of all, serves as a means to enable an operator to run application software and thereby prescribe the acquisition of particular images from the image acquisition apparatus (i.e., medical imaging apparatus). The medical imaging apparatus serves as an image data generation means that utilizes one of the imaging modalities to scan a patient under examination and thereby produce raw image data relating to a region of interest (ROI) within the patient. The image reconstruction processor serves to reconstruct images from the acquired image raw data. The image pixel data storage apparatus serves to store retrievable image files with image pixel data and informational attributes. Typically, the hardware of a conventional medical imaging apparatus is designed to implement and/or carry out such basic features and/or functions, and application software is designed and written for operating the medical imaging apparatus while particularly accommodating the medical imaging apparatus” more unique hardware features, configuration characteristics, and capabilities. Thus, when the hardware configuration of a medical imaging apparatus is somewhat changed to take advantage of new operating methods or new feature products such as, for example, different, faster, and more powerful microprocessors, much to all of the source code of the application software for the medical imaging apparatus must typically be painstakingly rewritten.

Today, a significant challenge facing manufacturers, designers, and/or developers of medical imaging apparatuses and related equipment is keeping abreast of all of the state-of-the-art improvements that are rapidly being developed in the underlying sciences associated with each respective imaging modality. In magnetic resonance imaging, for example, new pulse sequences and related image data acquisition methods are continuously being invented. To incorporate or implement such improvements within an existing magnetic resonance imaging apparatus and associated operator-interactive workstation computer system, the source code of both the system software and the application software typically needs to be rewritten. The difficulty and extent of such an undertaking generally depends on the particular improvement being implemented on the medical imaging apparatus and also the inherent nature of the system software architecture that already exists on the medical imaging apparatus and/or workstation computer system.

At the present time, magnetic resonance imaging in particular is expanding its clinical role greatly through the creation of a whole new family of real-time operator-interactive software applications that are generally memory-stored on the workstation computer system interfaced to a magnetic resonance imaging apparatus. These software applications are no longer simply just a predetermined pulse sequence coupled to a monolithic reconstruction and “one size fits all” operator interface. Instead, the current generation of software applications now generally require a software developer or operator himself to custom-create software application pulse sequences, user interfaces, reconstruction, visualization, processing, geometries, control, et cetera in potentially a unique way for each magnetic resonance imaging apparatus application. In light of such, it is therefore most preferable that magnetic resonance imaging apparatus manufacturers develop and incorporate underlying system software architectures that will facilitate the enabling of a research software developer, a commercial software developer, and even sometimes an operator to custom-create and tailor application software as desired. In this way, given the modern accelerating pace of application software development, the ability to rapidly prototype software applications and software application components, share such applications and application components amongst developers or operators for preliminary testing, and quickly make any necessary modifications thereto will be realized. In providing such an ability, the successful research and development, as well as the commercial success, of magnetic resonance imaging apparatus systems and their many potential real-world applications will also be realized.

As briefly alluded to earlier hereinabove, image files produced by a medical imaging apparatus system are preferably encoded in accordance with DICOM standards. In general, each image file typically includes both image pixel data and an image header. The image header includes numerous informational attributes as described in detail earlier hereinabove. In this way, once image pixel data is produced by a medical imaging apparatus system and thereafter captured, processed, and incorporated in a DICOM-format image file together with image header informational attributes, the image header along with its informational attributes can then be selectively displayed by an operator on a monitor screen together with its associated digital image(s) as constructed from the image pixel data.

In current medical imaging apparatus systems, non-DICOM image headers are sometimes generated with an essentially fixed-size data structure. Since the image header is a fixed size, it is very difficult for software developers and/or operators to include or represent numerous informational attributes therein, especially optional attributes. In addition, it is also very hard for software developers and/or operators to introduce new informational attributes or even add “private” informational attributes in such fixed-size image headers. Consequently, as available space within a given image header is further used up with each added informational attribute, overloading informational attributes therein with encoded information having multiple meanings is often cleverly attempted by a software developer and/or operator to thereby include more information within the image header. Ultimately, however, overloading informational attributes in such a manner often renders such informational attributes difficult to maintain and even more difficult to subsequently interpret and understand.

Presently, in order to increase image header sizes and/or to enable software developers or operators to include additional informational attributes including some private informational attributes within image headers, significant source code changes must necessarily be made in the underlying system software architecture and/or operator-run software applications. The software development process in implementing such source code changes generally has two phases, the “producer side” phase and the “consumer side” phase. The producer side phase refers to the development of software that will help provide or produce the actual information or value for a particular newly proposed informational attribute. Thus, in order to facilitate the enabling of a software developer or operator to selectively add such an informational attribute to an image header, software source code that will help produce the value for that informational attribute first needs to be written. The consumer side phase, on the other hand, refers to the development of software source code that helps “carry” or transport the produced value of the informational attribute to the image header by matching up and binding the produced value with its respective informational attribute name. In this consumer side phase, many steps including changing image header structure, rebuilding several processes, testing, and updating the DICOM translator and conformance statement must be performed. In sum, therefore, software source code revision and development between the two phases is necessarily highly coupled and interrelated. As an ultimate result, the whole software source code revision process is highly iterative, complex, time-consuming, and therefore often error prone. Such is highly undesirable in today's commercially competitive environment of rapidly developing medical imaging technology.

In light of the above, there is a present need in the art for a system and/or method for enabling a software developer to introduce new or modified informational attributes that are suitable for selective inclusion within image headers for medical imaging applications. Such a system and/or method preferably necessitates only minimal to no revisions in the software source code executed on a medical imaging apparatus system each time that a new or modified informational attribute is proposed therefor.

### SUMMARY OF INVENTION

The present invention provides both a system and a method for enabling a developer to introduce new or modified informational attributes that are suitable for selective inclusion within image headers for imaging applications. The image headers, along with their selectively included informational attributes, are displayable on a monitor screen together with associated digital images produced by an imaging apparatus. The image headers are also selectively storable in a database together with the pixel data of the associated digital images.

In a basic embodiment, the system includes, first of all, an interactive workstation computer system. The interactive workstation computer system is electrically connectable to a database, is electrically connectable to an imaging apparatus, and has memory-stored software applications for operating the imaging apparatus. In addition, the system also includes a memory-stored updatable table of defined informational attributes suited for selective inclusion within image headers. Lastly, the system also includes an interactive computer for generating software files of image header definitions from the table of defined informational attributes, and a means to transport the software files of image header definitions to the interactive workstation computer system.

In a basic methodology, the method includes the steps of (a) generating software files of image header definitions from a memory-stored updatable table of defined informational attributes suited for selective inclusion within image headers, and (b) transporting the software files of image header definitions to an interactive workstation computer system having memory-stored software applications for operating an imaging apparatus.

Advantages, design considerations, and applications of the present invention will become apparent to those skilled in the art when the detailed description of the best mode contemplated for practicing the invention, as set forth herein below, is read in conjunction with the accompanying drawings.

### BRIEF DESCRIPTION OF DRAWINGS

The present invention will be described, by way of example, with reference to the following drawings.

FIG. 1 is a block diagram of a generic medical imaging apparatus system upon which at least part of the present invention is based.

FIG. 2 is a diagram of a system for enabling a software developer to introduce new or modified informational attributes that are suitable for selective inclusion within image headers for medical imaging applications, wherein a developer-interactive simulation computer system, an electrical communications network, a developer-interactive computer with a memory-stored table of informational attributes, a developer-interactive medical imaging apparatus system for integration testing, and an operator-interactive medical imaging apparatus system for clinical use are all highlighted.

FIG. 3 is a block diagram of both a prescription controller and an application controller that are operative within both interactive workstation computer systems included in the medical imaging apparatus systems illustrated in FIG. 2.

FIG. 4 is a block diagram of a tag communication system that is operative within both interactive workstation computer systems included in the medical imaging apparatus systems illustrated in FIG. 2.

FIG. 5 is a block diagram of the prescription controller of FIG. 3 during a prescription download event.

FIG. 6 is a flowchart of an example of a method for enabling a software developer to introduce new or modified informational attributes that are suitable for selective inclusion within image headers for medical imaging applications.

FIG. 7 is a screen view of the monitor associated with the developer-interactive simulation computer system illustrated in FIG. 2, wherein the “framework”, “workspace”, and “properties” fields of the visually oriented application development software MRAppStudio™, utilized for the drag-and-drop creation and modification of informational attributes, are all highlighted.

FIG. 8 is a screen view of the monitor associated with the operator-interactive workstation computer system included in the medical imaging apparatus system for clinical use illustrated in FIG. 2, wherein selected informational attributes are displayed together with associated scanned digital images.

FIGS. 9 and 10 are diagrams that illustrate the various ways in which produced values for selected informational attributes are matched up and bound together with their respective informational attribute names for ultimate inclusion within an image header.

### DETAILED DESCRIPTION

The present invention provides both a system and a method for enabling a software developer to introduce new or modified informational attributes that are suitable for selective inclusion within image headers for medical imaging applications. The image headers, along with their selectively included informational attributes, can be formatted for display on a monitor screen together with associated digital images produced by a medical imaging apparatus. The image headers are also selectively storable in a database together with the pixel data of the associated digital images.

In general, the present invention is based upon a system architecture for medical imaging apparatus systems and, even more particularly, an improved software architecture for such systems. The system architecture includes an operator-interactive workstation computer and a plurality of server computers. The workstation computer, first of all, is programmed in a hardware-independent computer programming language to provide an operator interface for receiving and capturing image pixel data. Through the workstation computer, an operator is able to prescribe a particular desired digital image to be acquired from a medical imaging apparatus, to custom-create an image acquisition description from software application components which determine how the medical imaging apparatus system is to be operated so that image data can be acquired therefrom, and to custom-create a data processing description comprised of software application components which determine how the acquired image data is processed to thereby reconstruct an image for selective viewing on the screen of a monitor. The plurality of servers, on the other hand, are coupled to the workstation computer and are each operable to respectively receive one of the custom-created scan descriptions as they are downloaded from the workstation computer. Upon receiving their respective downloaded descriptions, the plurality of servers are then able to collectively carry out and perform medical imaging operations on a medical imaging apparatus interfaced thereto in addition to subsequent image processing as prescribed by the operator. By employing a hardware independent computer programming language such as Java™ on the workstation computer, the hardware on the workstation computer may easily be changed or updated with few to no changes necessary in the software responsible for producing the descriptions. Similarly, much of the software on the plurality of servers employed to carry out and perform the descriptions downloaded from the workstation computer may also be hardware independent.

In addition to the above-described system architecture and software architecture, another feature upon which the present invention is generally based is the manner in which the scan descriptions are downloaded from the workstation computer to the plurality of servers. In particular, the workstation computer, first of all, includes a software-implemented serialization mechanism that sends the scan descriptions as a stream of components to their respective servers. Each of the plurality of servers, on the other hand, includes a deserialization mechanism that rebuilds the particular description respectively received from the workstation computer so that the description is able to appropriately direct operation of the server to thereby ultimately help control operation of the medical imaging apparatus during scanning operations.

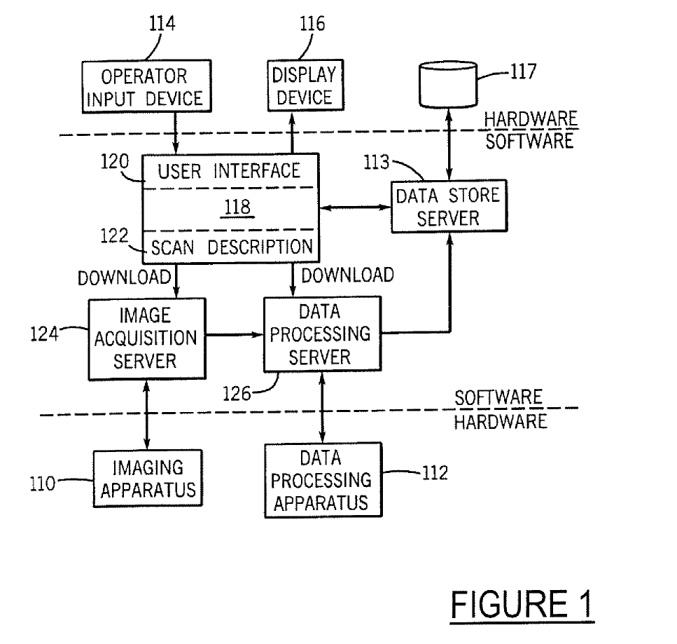

FIG. 1 is a block diagram of a generic medical imaging apparatus system upon which at least part of the present invention is based. As depicted, the medical imaging apparatus system includes a medical imaging apparatus 110 having both mechanical and electrical “hardware elements” that are operable during a scanning operation to acquire image data. In addition to the medical imaging apparatus 110, the medical imaging apparatus system also includes a data processing apparatus 112. The data processing apparatus 112 is both operable and able to reconstruct images from image data acquired from the medical imaging apparatus 110. To effectively operate the medical imaging apparatus system by entry of an operator-initiated scan prescription, an operator input device 114, including a control panel, a keyboard, and a pointing device, is provided. In addition to the operator input device 114, both a display device 116 and an image storage device 117 are provided as well. The display device 116 is provided to visibly present acquired images for an operator's or other medical professional's viewing. The image storage device 117 is provided for selectively archiving the digital image pixel data of acquired images and may itself include, for example, a hard disk drive. Given such to this point, however, it is to be understood that the particular imaging modality utilized by the medical imaging apparatus system, as well as the complexity and power of the hardware elements incorporated therein, may indeed be varied from one system to another pursuant to the present invention.

In addition to the above, the medical imaging apparatus system in FIG. 1 also includes a workstation computer 118. The workstation computer 118 is programmed in a hardware or machine independent language, such as Jav™, to thereby provide a user interface 120 that enables an operator to enter desired scan parameters utilizing the operator input device 114. Furthermore, the workstation computer 118 is also programmed to produce a scan description 122. In its simplest configuration, the scan description 122 itself contains both image acquisition description components and data processing description components that contain information required by the medical imaging apparatus 110 and data processing apparatus 112 to properly carry out and perform an operator-prescribed scanning operation.

Just prior to run time on the medical imaging apparatus 110, a snap shot of the scan description 122 is downloaded to a plurality of servers that generally control the system hardware closely associated with the medical imaging apparatus 110. In the simplest configuration, the plurality of servers includes an image acquisition server 124 and a data processing server 126. Both the image acquisition server 124 and the data processing server 126 operate cooperatively to generally control both the medical imaging apparatus 110 and the data processing apparatus 112 during scanning operations. When provided with the downloaded scan description 122 containing both the image acquisition description components and the data processing description components, programs within the servers 124 and 126 then interpret the servers” respectively received description components and accordingly direct both the medical imaging apparatus 110 and the data processing apparatus 112 of the medical imaging apparatus system's hardware to perform the operator-prescribed scanning operation. After each prescribed scanning operation, a data store server 113 then directs the image storage device 117 to store and save the image pixel data of acquired images together with associated patient and other information therein as selectively desired by the operator.

The “software elements” associated with the overall medical imaging apparatus system in FIG. 1 may easily be configured to run on various different hardware configurations. That is, system software and/or application software associated with and run on the workstation computer 118, the data store server 113, the image acquisition server 124, and/or the data processing server 126 may either run on separate programmable machines or run on the same programmable machine. For example, software associated with and run on the data processing server 126 and/or the data store server 113 depicted in FIG. 1 may alternatively run on the data processing apparatus 112 and/or on the workstation computer 118. Thus, regardless of the hardware configuration, because the workstation computer 118 is programmed in a hardware or machine independent computer programming language, system software and/or application software may easily be transported therefrom to run on different programmable machines associated therewith. In addition, even if the software associated with the servers 113, 124, and 126 were to be changed to run on different programmable machines, little change would be required in the software of the workstation computer 118 since the scan description downloaded therefrom during prescription is originally created in a hardware independent computer programming language. In particular, if software changes are indeed made within the servers 113, 124, and 126, the only changes that may be required in the software associated with the workstation computer 118 will be minor changes in the individual scan description software components that are downloaded to the servers 113, 124, and 126 during prescription.

Despite the particular hardware configuration suggested in FIG. 1, it is to be understood that the number of servers included therein may alternatively be increased without the need for significant changes in either the hardware or the software of the workstation computer 118. For example, if the image acquisition server 124 were to be split into two or more separate servers, the only substantial changes necessary for the workstation computer 118 would be to correspondingly add hardware connections between the workstation computer 118 and any additional server and also correspondingly tweak the software within the workstation computer 118 so that an additional server-specific description component is correspondingly downloaded to each additional server.

To accommodate the various hardware configurations that may possibly be utilized within a given medical imaging apparatus system pursuant to the present invention, operator-selectable software applications and software application components memory-stored in the workstation computer 118 are generally written in a hardware independent format such as the Java™ class file format. Object-oriented software applications are formed from multiple class files that are accessed from servers and downloaded individually as needed. Class files contain byte code instructions. A “virtual machine” process that executes on a specific hardware platform loads the individual class files and executes the byte codes contained therewithin.

The present invention is preferably implemented using object-oriented computer software programming methods. In general, “object-oriented programming” is a method by which computer software programs are created by first selectively combining certain fundamental software building blocks and thereafter selectively creating relationships among and between the combined software building blocks. Such software building blocks defined within a given object-oriented computer software programming system are called “objects.” In general, an “object” is a programming unit that groups together a data structure (i.e., one or more instance variables) with the operations (i.e., methods) that can use or affect that data. Thus, more particularly, a given object consists of specific information, value(s), or data in addition to one or more actions, procedures, or operations that can be performed on that data. The joining of such data and operations into a single, unitary building block is often called “encapsulation.”

Given such, an encapsulated object can be instructed to perform one of its operations or methods when it receives a message. In general, a “message” is an instruction sent to the object commanding the object to execute a particular method. Such a message consists of a method selection (i.e., a particular method name) and a plurality of arguments. The message essentially dictates to the receiving object what operations to perform. In light of such, one advantage of object-oriented computer software programming is the way in which methods are invoked. That is, when a message is sent to an object, it is not necessary for the message to instruct the object on how to perform a certain method. Instead, it is only necessary for the message to request that the object execute the method.

Typically, object-oriented computer software programming languages are predominantly based on a class scheme. In particular, a “class” defines a type of object that typically includes both variables and methods associated with the particular class. In general, an object class is used to create a particular instance of an object. An “instance” of an object class includes the variables and methods defined for the class. Multiple instances of the same class can be created from a given object class. Each instance that is created from the object class is said to be of the same type or class.

In sum, therefore, an “object” is a generic term that is utilized in the object-oriented computer software programming realm to refer to a single module that contains both related software code and software variables. The characteristic functionality of a given software application written and composed in an object-oriented computer software programming language is defined by the particular objects assembled together and thereby implemented within the software application.

A Java™ computer software application or program, in particular, is composed of a number of classes and interfaces. Unlike many computer software programming languages in which a composed software application is compiled into machine-dependent and executable software program code, Java™ classes are instead compiled into machine-independent bytecode class files. Each class contains code and data in a platform-independent format called the “class file” format. In addition, the computer system acting as the software execution vehicle contains a program called a “virtual machine,” which is responsible for executing the software code in Java™ classes. The virtual machine provides a level of abstraction between the machine independence of the bytecode classes and the machine-dependent instruction set of the underlying computer system hardware. A “class loader” within the virtual machine is responsible for loading the bytecode class files as needed, and either an interpreter executes the bytecodes directly or a just-in-time compiler transforms the bytecodes into machine code so that they can be executed by a processor.

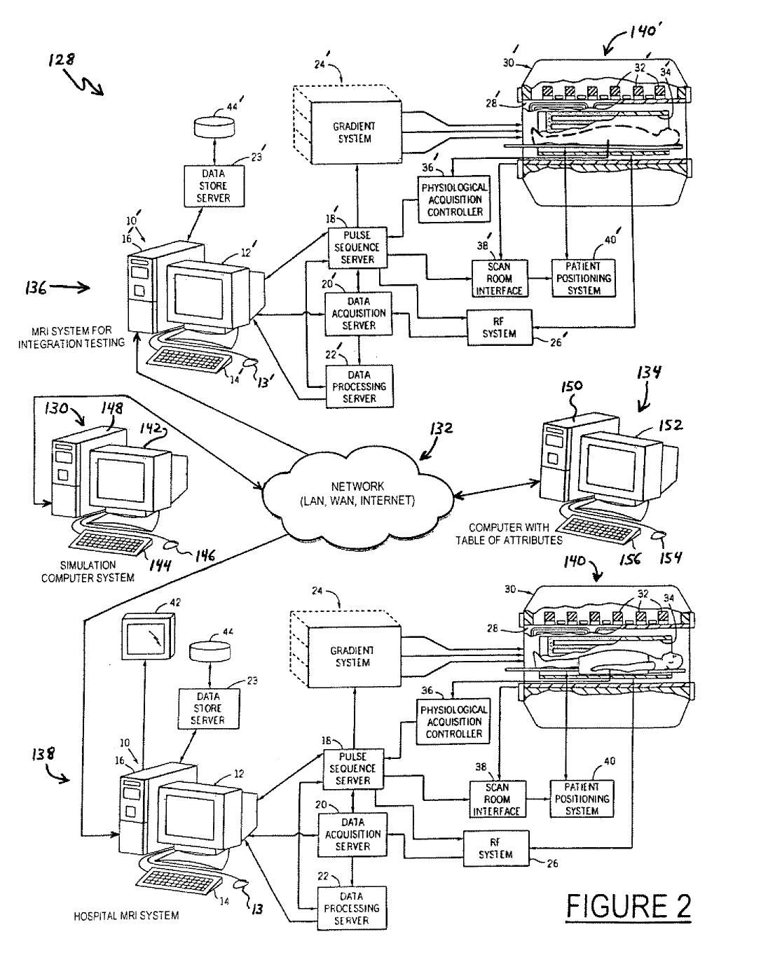

FIG. 2 is a diagram of a system 128 for enabling a software developer to introduce new or modified informational attributes that are suitable for selective inclusion within image headers for medical imaging applications. As illustrated, the system 128 includes a developer-interactive simulation computer system 130, an electrical/wireless (including WIFI) communications network 132, a developer-interactive computer 134 with a memory-stored updatable table of defined informational attributes, a developer-interactive medical imaging apparatus system 136 designated for integration testing, and an operator-interactive medical imaging apparatus system 138 suited for actual clinical use. Though both the developer-interactive medical imaging apparatus system 136 and the operator-interactive medical imaging apparatus system 138 within the system 128 as depicted in FIG. 2 are particularly shown to utilize magnetic resonance imaging (MRI) modalities to scan and capture images, it is important to note that other imaging modalities may instead be implemented and utilized in alternative embodiments pursuant to the present invention.

The developer-interactive simulation computer system 130, first of all, includes a processor 148, a display monitor 142, a keyboard 144, and a pointing device 146. The simulation computer system 130, in general, has software suitable for creating and modifying defined informational attributes and also simulating application software driven operation of the medical imaging apparatus 140 of the medical imaging apparatus system 138 suited for clinical use. More particularly, however, the developer-interactive simulation computer system 130 specifically includes visually oriented application development software. In using such visually oriented application development software, a research or commercial software developer is able to utilize the pointing device 146 for performing both point-and-click and drag-and-drop operations on previously defined informational attributes and/or previously defined informational attribute components displayed on the screen of the display monitor 142 to thereby selectively create newly defined informational attributes and/or selectively modify previously defined informational attributes as desired for potential future use in actual medical imaging and scanning operations. In this way, a software developer is thereby able to quickly create and/or modify informational attributes as desired without having to laboriously write new or revised software source code. Given that the medical imaging apparatuses 140″ and 140 in the particular embodiment depicted in FIG. 2 are both magnetic resonance imaging (MRI) type apparatuses, the visually oriented application development software may be, for example, MRAppStudio™. Once the informational attributes are created and/or modified in this manner, the software suitable for simulating application software driven operation of the medical imaging apparatus 140 may then be utilized by the software developer on the simulation computer system 130 to preliminarily determine whether the informational attributes are compatible with imaging application software.

The electrical communications network 132, in turn, is electrically connected to the developer-interactive simulation computer system 130. The electrical communications network 132 itself may include, for example, a local area network (LAN), a wide area network (WAN), the Internet, any type of Ethernet-based network, or any number or combination thereof. With such an electrical communications network 132, various types of computer software files and/or data may be transported between and among the primary elemental computers, apparatuses, and devices that make up the overall system 128 in FIG. 2.

The developer-interactive computer 134, next of all, is electrically connected to the electrical communications network 132 as well and includes a processor 150, a display monitor 152, a keyboard 156, and a pointing device 154. The developer-interactive computer 134, in general, includes a memory-stored updatable table of defined informational attributes suitable for selective inclusion within image headers for medical imaging applications. More particularly, the developer-interactive computer 134 specifically includes spreadsheet application software for enabling a commercial software developer to both update and maintain the table of defined informational attributes. Such spreadsheet application software itself may include, for example, Excel™. The actual table may include rows, columns, and/or lists of variously defined and various types (1, 2, 3, or “private”) of informational attributes, group elements, data types, and value types. With such spreadsheet application software, a software developer can thereby maintain separate lists of, for example, defined informational attributes approved for research imaging applications only, defined informational attributes approved for actual clinical imaging applications, defined informational attributes approved for vendor use, defined informational attributes approved for customer use, et cetera. Furthermore, in addition to including such a memory-stored updatable table of informational attributes, the developer-interactive computer 134 may also optionally include, similar to the simulation computer system 130, software suitable for creating and modifying defined informational attributes and also simulating application software driven operation of the medical imaging apparatus 140 of the medical imaging apparatus system 138 suited for clinical use.

The developer-interactive medical imaging apparatus system 136 designated for integration testing, in turn, is electrically connected to the electrical communications network 132 as well. The medical imaging apparatus system 136 itself primarily includes a developer-interactive workstation computer 10′, a database 44′, a data store server computer 23′, a medical imaging apparatus 140′, and a network of additional server computers including a pulse sequence server computer 18′, a data acquisition server computer 20′, and a data processing server computer 22′.

The developer-interactive workstation computer 10′, in brief, is electrically connected to both the data store server computer 23′ and the network of additional server computers. To facilitate interaction with a software developer or operator, the workstation computer 10′ includes a display monitor 12′, a keyboard 14′, and a pointing device 13′ accompanied by a processor 16′. In addition thereto, the workstation computer 10′ also has memory-stored updatable collections of defined software applications and defined software application components suitable for operating the data store server computer 23′, the network of additional server computers, and the medical imaging apparatus 140′. These memory-stored updatable collections of defined software applications and defined software application components are preferably written in an object-oriented computer programming language such as, for example, Java™. In addition, the developer-interactive workstation computer 10″ also includes software for supporting a Java™ virtual machine. With the Java™ virtual machine, a software developer is able to execute Java™ software applications selected from the collections of defined software applications and defined software application components to thereby perform scanning operations on the medical imaging apparatus 140′ for purposes of integration testing. Furthermore, the developer-interactive workstation computer 10′ also includes software for supporting InfoBus data exchanges to thereby facilitate the selective inclusion of informational attributes within generated image headers during scanning operations.

The database 44′, in association with the medical imaging apparatus 140′, is capable of retaining image headers and pixel data of associated digital images for storage and selective retrieval. The database 44′ itself may include one or more storage mediums such as, for example, a magnetic tape, a magnetic disk, a magneto-optical disk (MOD), an optical disk, a floptical disk, a floppy disk, a Zip disk, a hard disk, a disk cartridge, a tape cassette, a compact disc (CD), or a digital versatile disc (DVD).

The data store server computer 23′, in turn, is electrically connected to both the database 44′ and also the developer-interactive workstation computer 10′ associated with the medical imaging apparatus 140′. Within such a configuration, the data store server computer 23′ is capable of collecting pixel data of digital images, generating image headers, and storing the image headers together with the pixel data in the database 44′ in DICOM format. The data store server computer 23′ may optionally include direct memory access (DMA) hardware for directly obtaining digital pixel data, of images produced by the medical imaging apparatus 140′, from at least one of the network server computers 18′, 20′, and 22′.

The network of additional server computers, in general, is electrically connected to the data store server (DSS) computer 23′ via the workstation computer 10′ and is also electrically connected to the medical imaging apparatus 140′. With particular regard to both the data store server computer 23′ and the workstation computer 10′, in a commonly preferred embodiment, the network of additional server computers is interfaced with the data store server computer 23′ in such a way that the four servers 18′, 20′, 22′, and 23′ together form a four-server network. Within such a four-server network, the data store server computer 23′ typically is substantially integrated with the workstation computer 10′ and is commonly housed therewith. When integrated in this fashion, at least one of the server computers 18′, 20′, and 22′ is typically connected to the workstation/DSS combination via a direct memory access (DMA) interface. Given such a configuration, the network of additional server computers is capable of delivering operation control signals to the medical imaging apparatus 140′, acquiring raw MRI data of images produced by the medical imaging apparatus 140′, processing the raw MRI data, and ultimately delivering digital image pixel data to the data store server computer 23′. Furthermore, the pulse sequence server computer 18′, the data acquisition server computer 20′, and the data processing server computer 22′ that specifically make up the network of additional server computers are particularly interconnected and may each include real-time operating system (RTOS) software (such as VxWorks).

Lastly, the medical imaging apparatus 140′ included within the medical imaging apparatus system 136 of FIG. 2 is a magnetic resonance (MRI) type imaging apparatus. As alluded to earlier hereinabove, however, it is to be understood that the medical imaging apparatus 140′ may instead be, in an alternative embodiment, a computerized tomography (CT) imaging apparatus, an ultrasound imaging apparatus, an x-ray imaging apparatus, or some other medical imaging apparatus. In general, the overall developer-interactive medical imaging apparatus system 136 designated for integration testing is, by design, substantially similar or even identical to the operator-interactive medical imaging apparatus system 138 suited for actual clinical use. In this way, when a software developer conducts application software driven integration tests on the medical imaging apparatus system 136 with favorable results, it can then be generally assumed that such application software will run properly and favorably on the medical imaging apparatus system 138 as well.

Despite the sole depictions of both the simulation computer system 130 and the medical imaging apparatus system 136 designated for integration testing set forth within the overall system 128 in FIG. 2, it is to be understood that multiple similar and/or intermediary simulation computer systems or integration testing systems may additionally be added to the overall system 128 as well. In this way, multiple and progressive steps or levels of simulation and/or integration testing that differ in test emphasis, test thoroughness, and overall technical sophistication may be included within the overall system 128. For example, on a first level, simulation and/or integration testing may initially be conducted with the simulation computer system 130 by running scan sub-system emulation software on the processor 148 to thereby particularly emulate operation of the pulse sequence server computer 18, the data acquisition server computer 20, the data processing server computer 22, and the medical imaging apparatus 140. On a second level, a scan hardware sub-system (not shown) that physically includes a pulse sequence server computer 18, a data acquisition server computer 20, and a data processing server computer 22 while physically excluding and yet software-emulating a medical imaging apparatus 140 may next be utilized for simulation and/or integration testing. On a third level, a full-hardware “bay” medical imaging system, such as the medical imaging apparatus system 136 in FIG. 2, may ultimately be utilized for final simulation and/or integration testing at, for example, a factory or other manufacturing facility.

Given such a configuration for the overall system 128 in FIG. 2, a research or commercial software developer is able to utilize the developer-interactive simulation computer system 130 for selectively creating newly defined informational attributes, selectively modifying previously defined informational attributes, and simulating application software driven operation of the medical imaging apparatus 140 to thereby test newly created and modified informational attributes for desirability and compatibility with application software. Once developed and preliminarily tested in this manner, any one or more newly created and/or modified informational attributes which are identified as being both application software compatible and desirable for research, commercial, private, and/or clinical use are transported across the electrical communications network 132 to the developer-interactive computer 134. Upon receipt of the proposed informational attributes, a commercial software developer is then able to utilize the developer-interactive computer 134 for selectively including the newly created and/or modified informational attributes in the table of defined informational attributes to thereby update the table. In including the newly created and/or modified informational attributes in the table, many of such preliminarily tested informational attributes may be categorized into various different sets such as, for example, sets suitable for research use by certain commercial vendors, sets suitable for research use by certain private entities, sets suitable for research use by universities, “vendor released” sets, “vendor test” sets, “research test” sets, vendor-specific “private” attributes, research or customer “private” attributes, et cetera. Once included in the table in this manner, software files of image header definitions are then generated from the updated table of defined informational attributes by utilizing one or more software application tools. In utilizing such software application tools, the software files of image header definitions generated thereby are particularly put in the form of extensible markup language (XML) type software files to facilitate easy electronic transfer of the files across, for example, the Internet. Thus, once generated, the XML software files of image header definitions may then transported, via the electrical communications network 132, to the developer-interactive workstation computer 10′ of the medical imaging apparatus system 136 for thorough integration testing.

Once the XML software files of image header definitions are received and downloaded onto the developer-interactive workstation computer 10′, a commercial software developer or operator is able to utilize the workstation computer 10′ for executing software applications selected from the collections of defined software applications and defined software application components. In this way, the software developer is able to execute selected software applications to thereby deliver operation control signals to the medical imaging apparatus 140′, acquire raw MRI data of images produced by the medical imaging apparatus 140′, process the raw MRI data, read the XML software files of image header definitions, generate image headers that selectively include informational attributes as specified by the XML software files, display the image headers together with associated digital images indirectly produced by the medical imaging apparatus 140′, and selectively store the image headers together with the pixel data of associated digital images in the database 44′ in DICOM format. In performing such integration testing on the medical imaging apparatus system 136, an actual living patient is typically not utilized during the scanning operations of the medical imaging apparatus 140′.

Once integration testing on the medical imaging apparatus system 136 is completed and the newly created and/or modified informational attributes are tweaked as necessary and ultimately deemed fully application software compatible, the table of defined informational attributes maintained on the developer-interactive computer 134 is again accordingly updated. In doing so, the newly created and/or modified informational attributes may, for example, be redesignated and tagged as being suitable for actual clinical imaging applications or be categorized into various different sets such as, for example, sets suitable for research use by certain commercial vendors, sets suitable for research use by certain private entities, sets suitable for research use by universities, “vendor released” sets, “vendor test” sets, “research test” sets, vendor-specific “private” attributes, research or customer-specific “private” attributes, et cetera. Once redesignated and/or categorized as such, the newly created and/or modified informational attributes may then be transported via the electrical communications network 132 to, in the present example of FIG. 2, the medical imaging apparatus system 138 which is suited for clinical use in a hospital. It is to be understood, however, that various sets or categories of informational attributes may alternatively be transported to other sites or entities as well such as, for example, commercial vendor corporations, both public and private universities, various medical facilities, et cetera. In the present example, however, the informational attributes are particularly delivered to the hospital as part of a new or updated imaging application software package that, for example, was purchased by the hospital from a commercial corporation that specializes in developing new medical imaging technologies. Once the imaging application software package with newly created and/or modified informational attributes is received as such, a medical professional operator at the hospital is then able to utilize the operator-interactive workstation computer 10 associated with the medical imaging apparatus 140 to execute software applications selected from the updated collection of defined software applications and defined software application components included within the software package. In this way, the medical professional operator is able to execute selected software applications to thereby deliver operation control signals to the medical imaging apparatus 140, acquire raw MRI data of images produced by the medical imaging apparatus 140, process the raw MRI data, read the software files of image header definitions, generate image headers that selectively include informational attributes as specified by the software files, display the image headers together with associated digital images indirectly produced by the medical imaging apparatus 140, and selectively store the image headers together with the pixel data of associated digital images in the database 44 in DICOM format.

Similar to the medical imaging apparatus system 136 designated for integration testing, the medical imaging apparatus system 138, in further detail, includes an operator-interactive workstation computer 10 having a display monitor 12, a keyboard 14, and a pointing device 13. In addition thereto, the workstation computer 10 also includes a processor 16 which is a programmable machine (an IA32 computer). The processor 16 is based on a 64-bit microprocessor manufactured by Intel Corporation and runs the Linux operating system. The workstation computer 10 essentially serves as an operator interface that enables scan operation prescriptions to be entered by an operator and thereafter run on the medical imaging apparatus system 138. As described in further detail herein below, the workstation computer 10 runs one or more Java™ virtual machines that run software application code which is written in the Java™ computer software programming language. By writing software application code in a hardware independent programming language such as Java™, the code is then fully transportable to any other programmable machine that is Java™ compatible. That is, the same Java™ programs can be run on different workstation computers having different hardware configurations and capabilities. As an ultimate result, such programs can easily be transferred to and run on newer, updated programmable machines that are developed to take advantage of rapid advances in integrated circuit technology.

As illustrated in FIG. 2, the workstation computer 10 is interfaced with and connected to four server computers including, in particular, a pulse sequence server computer 18, a data acquisition server computer 20, a data processing server computer 22, and a data store server computer 23. In an alternative embodiment, the data store server computer 23 may be functionally replaced by both the processor 16 and the associated disk drive interface circuitry associated with the workstation computer 10. In such an embodiment, the three remaining server computers 18, 20, and 22 may be functionally replaced by separate PowerPC processors mounted within a single common enclosure and electrically interconnected together with a 64-bit backplane bus structure based on the PCI standard for industrial and telecommunications applications called “CompactPCI.” The pulse sequence server computer 18, for example, may employ a 366 MHz microprocessor model PPC750 manufactured by Motorola Incorporated. The data acquisition server computer 20 and the data processing server computer 22, in turn, may both employ the same 366 MHz microprocessor, and the data processing server computer 22 may further include one or more “array processors” based on parallel vector processors made commercially available by Mercury Computer Systems Incorporated as the PowerPC™. Another 366 MHz microprocessor (not shown) may serve as a hardware controller on the PCI bus structure and thereby control a quad-communication controller model MPC86OT manufactured by Motorola Incorporated.

The workstation computer 10 and each of the processors associated with the server computers 18, 20, and 22 are connected to a 100 BaseT Ethernet serial communications network. As explained in further detail herein below, this serial network conveys data that is downloaded to the server computers 18, 20, and 22 from the workstation computer 10 and also conveys tag data that is communicated between the server computers 18, 20, and 22 themselves and also between the workstation computer 10 and the server computers 18, 20, and 22. In addition, a highspeed data link using the BIT3 protocol is provided between the data processing server computer 22 and the workstation computer 10. Such a high-speed data link serves to facilitate the transfer and communication of image pixel data from the data processing server computer 22 to the data store server computer 23, which in this embodiment is subsumed under workstation computer 10.

The pulse sequence server computer 18 functions in response to software application components downloaded from the operator-interactive workstation computer 10 to thereby operate both a gradient system 24 and an RF system 26. Gradient waveforms necessary to perform the operator-prescribed scan are produced and applied to the gradient system 24 which excites gradient coils in an assembly 28 to produce the magnetic field gradients Gₓ, G_{y}, and G_{z} used for position encoding NMR signals. The gradient coil assembly 28 forms part of a magnet assembly 30 that includes both a polarizing magnet 32 and a whole-body RF coil 34.

RF excitation waveforms are applied to the RF coil 34 by the RF system 26 to perform an operator-prescribed magnetic resonance scanning sequence. Responsive NMR signals detected by the RF coil 34 are received by the RF system 26, amplified, demodulated, filtered, and ultimately digitized as dictated by control signals produced by the pulse sequence server computer 18. Exemplary RF systems are described in both U.S. Pat. No. 4,952,877 and U.S. Pat. No. 4,992,736.

The pulse sequence server computer 18 also optionally receives patient data from a physiological acquisition controller 36. The controller 36 receives signals from a number of different sensors connected to the patient such as, for example, ECG signals from electrodes or respiratory signals from a bellows. Such signals are typically used by the pulse sequence server computer 18 to synchronize performance of the scan. In addition, the pulse sequence server computer 18 is connected to a scan room interface circuit 38 that receives signals from various sensors associated with the condition of the patient and the magnet system. It is through this same scan room interface circuit 38 that a patient positioning system 40 also receives commands to move the patient to desired positions during the scan.

In general, the pulse sequence server computer 18 exercises real-time control of the system elements within the medical imaging apparatus 140 during a scan operation. Given such, it is necessary that its hardware elements be operated with program instructions that are executed in a timely manner. As will be explained in further detail herein below, the pulse sequence server computer 18 is controlled during run-time by software programs written in a low-level programming language such as assembler, C, or C++. The description components for a scan prescription are downloaded from the workstation computer 10 in the form of objects. The pulse sequence server computer 18 contains programs that receive these objects using a deserialization mechanism. The pulse sequence server computer 18 also includes a program that converts the objects into C++ objects that are employed by the run-time programs. In a preferred embodiment, Java™ objects are downloaded, and the Java™ serialization mechanism is employed. The pulse sequence server computer 18, therefore, includes both hardware independent programs written in Java™ and hardware dependent programs. At the present time, it is contemplated that Java™ interpreters will eventually become fast enough that nearly all programs run on the pulse sequence server computer 18 will be written in hardware independent form.

As illustrated in FIG. 2, the digitized NMR signal samples produced by the RF system 26 are received by the data acquisition server computer 20. The data acquisition server computer 20 operates in response to description components downloaded from the workstation computer 10 to receive the real-time NMR data and provide buffer storage such that no data is lost by data overrun. In some scans, the data acquisition server computer 20 does little more than pass the acquired NMR data to the data processor server computer 22. However, in scans that require information derived from acquired NMR data to control the further performance of the scan, the data acquisition server computer 20 is programmed to produce such information and convey it to the pulse sequence server computer 18. For example, during pre-scans, NMR data is acquired and used to calibrate the pulse sequence performed by the pulse sequence server computer 18. Navigator signals may be acquired during a scan and used to adjust RF or gradient system operating parameters or to control the view order in which k-space is sampled. Furthermore, the data acquisition server computer 20 may be employed to process NMR signals used to detect the arrival of contrast agent in an MRA scan as is described in U.S. Pat. No. 6,167,293, issued on Dec. 26, 2000, and entitled “Method for Performing Magnetic Resonance Angiography Using a Contrast Agent.” In all of these examples, the data acquisition server computer 20 acquires NMR data and processes it in real time to produce information which is used to control the scan.

As with the pulse sequence server computer 18, the hardware elements of the data acquisition server computer 20 are operated at run-time with program instructions in a programming language such as assembler, C, or C++. As is explained in further detail herein below, the directions for its operation during a scan are downloaded from the workstation computer 10 in the form of objects. A server proxy receives the objects using the serialization mechanism, and the downloaded objects are converted into C++ objects that are employed to operate the data acquisition server computer 20 during run-time. As indicated earlier hereinabove, Java™ objects are preferably downloaded using a Java™ serialization mechanism.

The data processing server computer 22 receives NMR data from the data acquisition server computer 20 and processes it in accordance with description components downloaded from the workstation computer 10. Such processing may particularly include, for example, Fourier transformation of raw k-space NMR data to produce two or three-dimensional images, the application of filters to a reconstructed image, the performance of a backprojection image reconstruction of acquired NMR data, the calculation of functional MR images, the calculation of motion or flow images, et cetera.

Images produced by the medical imaging apparatus 140 and reconstructed by the data processing server computer 22 are conveyed back to the data store server computer 23, which itself is typically included within the workstation computer 10, where the data store server computer 23 ensures that the images are properly stored as selectively desired in, for example, the database 44. Real-time images are stored in a data base memory cache (not shown) from which they may be selectively conveyed to the display monitor 12 of the workstation computer 10 and/or a floor monitor 42 that is located near the magnet assembly 30 for ultimate viewing by operators, attending physicians, or other medical professionals. Batch mode images or selected real time images are stored in a database 44 or disc storage associated with the workstation computer 10. When such images have been reconstructed, the data processing server computer 22 notifies the data store server computer 23 associated with the workstation computer 10. In general, the workstation computer 10 may be utilized by an operator to archive produced images, produce films, or even send the images via the electrical communications network 132 to other remote facilities.

Directions for the particular operations to be performed by the data processing server computer 22 are downloaded from the workstation computer 10 as is described in further detail herein below. The time critical functions are performed with programs written in assembler, C, or C++, and the downloaded Java™ object directions must therefore be converted into corresponding executable code as described earlier hereinabove.

As alluded to earlier hereinabove, the operator-interactive workstation computer 10 includes a software-supported Java™ virtual machine (JVM) that executes programs written in the Java™ programming language. Such software on the workstation computer 10 is structured to execute defined “software applications” that may be selected and run by an operator. Such software applications generally correspond to clinical imaging procedures and therefore may perform operations such as, for example, executing a scan using an FSE pulse sequence, conducting a CEMRA dynamic study, conducting an fMRI study, conducting a runoff vascular study, performing image post processing, filming, and/or networking.

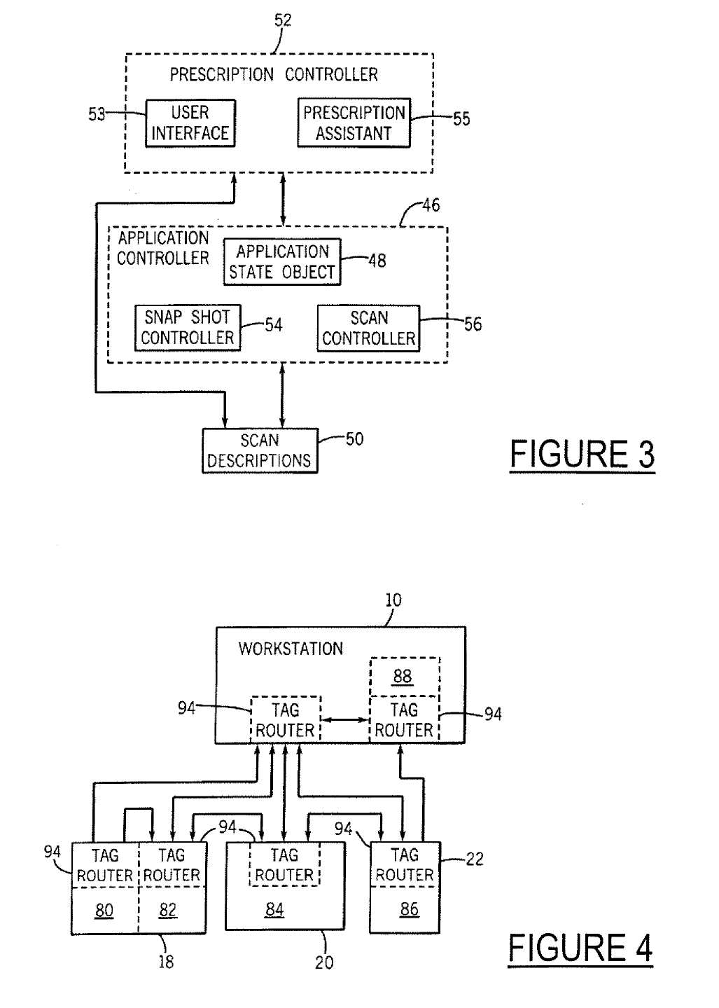

In general, a defined software application is a specific collection of defined Java™ software application components or Java™ objects that are selectively brought together in a common static design time “application container” that may be chosen by an operator to perform a scan. Referring particularly to FIG. 3, each application container includes a Java™ application controller component 46 that directs the other Java™ software application components within the application container to perform the scan. Such other software application components may include, for example, a prescription controller 52 which itself includes both a user interface component 53 and a prescription assistant component 55 that together enable an operator to control the particular scanning procedure performed by the defined software application.

The application container also includes scan descriptions 50. As is described in further detail herein below, these scan descriptions 50 are downloaded to the server computers 18, 20, 22, and 23 of FIG. 2 and are used by the server computers to perform the operator-prescribed scan. Such scan descriptions 50 are memory-stored in the workstation computer 10 and are unique for every different software application selectively executed by an operator. It is to be understood, however, that further information may be entered into the workstation computer 10 via the keyboard 14 and/or pointing device 13 by the operator to fully prescribe a particular scan operation.

As further illustrated in FIG. 3, the application controller 46 includes an application state object 48 that maintains the state of the software application as its associated scan is performed. The possible states during the life cycle of a given software application may include, for example, initialization, prescribing, prescribed, downloading, downloaded, prescanning, prescanned, batch scanning, real time scanning, scan paused, scanned, reconstructed, and visualized. Such a life cycle is driven by commands issued from the application container such as “initialize application,” by commands issued from the operator such as “start scan”, and by commands generated internally by the software application itself such as “scan done.”

“When an operator selects a particular software application for execution on the medical imaging apparatus system 138, the software application initializes and changes to the “prescribing” state, and the prescription controller 52 is enabled to interact with the scan description components 50 to determine what scan parameters must be specified by manual entry by the operator (for example, TR, number of slices, location of FOM flip angle) and to also determine if the operator prescription is complete and valid. Once the prescription is determined to be valid, the prescription controller 52 then signals the application state object 48 to switch to the “prescribed” state so that the “download”, “prescan”, and “scan” buttons on the control panel of the workstation computer 10 are enabled for operator activation.

If the operator activates the “download” button, the application state object 48 changes to the “download” state, and the application controller 46 employs a snap shot controller 54 to issue snap shot and download commands. As is described in further detail herein below, these commands cause the scan descriptions 50 to be downloaded to the server computers 18, 20, 22, and 23. Once the scan descriptions 50 are fully downloaded, the snap shot controller 54 receives “download done” notification back from each of the server computers 18, 20, and 22, and the application state object 48 is then changed to the “downloaded” state.

If the operator activates the “scan” button, the application state object 48 will change to the scan mode and a scan controller 56 is employed to issue a scan command to the pulse sequence server computer 18. The next state transition is governed by the scanning mode, that is, whether the scanning mode is real-time or batch. The behavior of the software application in the two modes is very different and so there are two different scanning states. If in real-time mode, the application state is set to a “real-time scanning” state. If in batch mode, the application state is set to a “batch scanning” state. When in the real-time mode, if the operator chooses to pause the scan, the application state will transition to a “scan paused” state. If scanning is resumed, the application state goes back to the “real-time scanning” state. In the “real-time scanning” state, the software application can be edited and edited descriptions will be downloaded even while the scanning is in progress. However, the application will not make a state transition; instead, the same state will be characterized to allow editing and downloading. It is this behavior of the “real-time scanning” state that differentiates it from the “batch scanning” state.

The application state will make a transition to the “scanned” state when the operator activates the “stop scan” button. Also, if the application is in the batch scanning mode of operation, the pulse sequence server computer 18 notifies the application controller 46 when the scan is completed. The application state object 48 changes to the “scanned” state in either event.

When the data processing server computer 22 completes reconstruction of the images acquired from the medical imaging apparatus 140, the application controller 46 is notified and the application state object 48 is changed to the “reconstructed” state. This indicates to the workstation computer 10 that reconstructed images are available on the database 44 for selective display or further processing as desired by the operator.

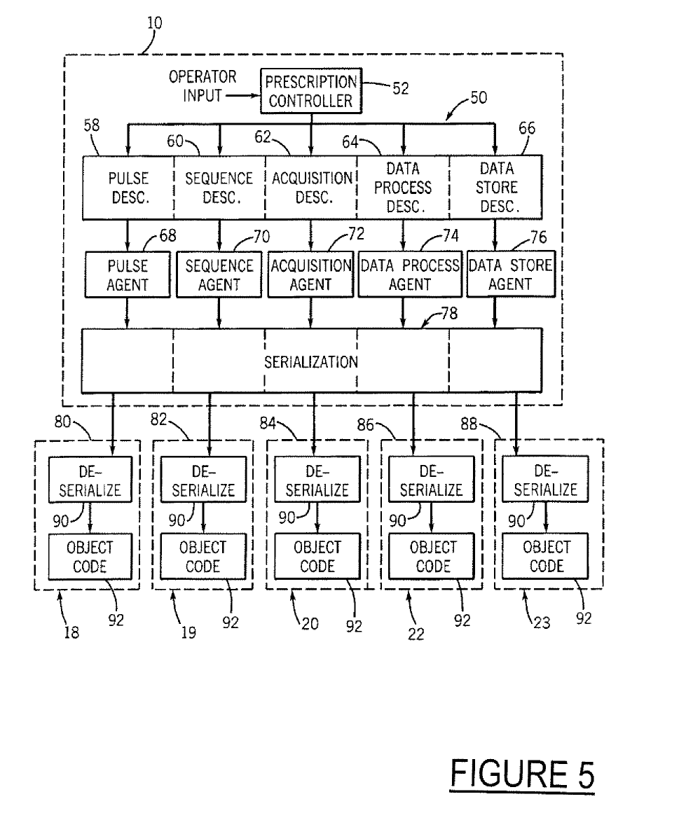

As illustrated in FIG. 5, the scan descriptions 50 contain a set of software components that serve to collect scan parameters using the prescription controller 52 and also to organize those prescription scan parameters into a set of smaller software components that can be downloaded to the server computers 18,20, 22, and 23. On the server computers 18, 20, 22, and 23, the software components downloaded thereto direct operation of the hardware in order to carry out the operator-prescribed scan via the server computers.

In general, there are different description types within each defined software application which themselves include logical groupings of software components that deal with different operational aspects of executing a scan on the medical imaging apparatus 140. Such description types primarily include, in particular, a pulse description (PLD) 58, a sequence description (SQD) 60, an acquisition description (AQD) 62, a data processing description (DPD) 64, and a data store description (DSD) 66.

The pulse description 58, first of all, includes software components that define and control the waveforms to be played out on the gradient system 24 and the hardware of the RF system 26 and also includes hardware control components as well. These components control the dynamic aspects of the waveforms and hardware in response to events produced at run-time by software components of the sequence description. The pulse description 58 also includes software components that control the filtering of NMR signals received by the RF system 26. These software components collectively define a unique set of gradient/RF/control pulses which are used to excite, encode, and readout the NMR signals. Examples include pulse descriptions for 2D spin-echo, 2D gradient-echo, 2D fast spin-echo, and 3D gradient-echo sequences.

The sequence description 60, next of all, includes a set of software components that control the order of pulse sequences played out and that also define a series of prescribed events along the scan timeline. These prescribed events defined by the sequence description 60 trigger the dynamic behavior of the pulse components in the pulse description 58. These components prescribe a unique acquisition ordering used to define the slice and k-space sampling order. Examples include 2D sequential, 2D interleaved, 3D sequential, 3D elliptical centric, and multi-slice CINE.

The acquisition description 62, in turn, includes a set of software components that prescribe the real-time processing of NMR signals acquired by the RF system 26. These software components direct the performance of operations on acquired NMR signals to produce information that is fed back to software components in the sequence description 60 to affect subsequent operation of the medical imaging apparatus 140. These software components may, for example, process NMR signals during a prescan to feedback changes in the power or frequency of RF pulses produced during the subsequent scan. Or, these software components may alternatively process NMR signals to detect when a bolus of contrast agent arrives in a region of interest (ROI) and trigger the start of a centric view order acquisition. Or, these software agents may alternatively process “navigator” NMR signals to produce phase correction information which may be used to alter the view order of the scan or alter the demodulation reference frequency of the RF system 26. There are scans commonly used in clinical applications which do not require this capability, however, and in those applications, the software components in the acquisition description 62 simply buffer the acquired NMR signals and make them available to the data processing server computer 22.

The data processing description 64, next of all, contains software components that direct the data processing server computer 22 to transform acquired NMR signals into a meaningful form. Image reconstruction is the most common function, and the resulting form is a 2D or 3D image of the patient being scanned. Spectroscopy processing can also be defined by these software components, in which case, the form that results is an image of the spectra of the acquired NMR signals.

The data store description 66, in turn, contains software components which define and identify the images produced by the medical imaging apparatus 140 that are to be selectively stored in, for example, the database 44 by the data store server computer 23 during or after a scan. In addition to the image pixel data of such images, informational attributes including, for example, patient information, scan parameter information, and/or patient anatomic or spectrographic information may also be stored by the data store server computer 23 in the database 44 together with the image pixel data in one or more image files. In general, the data store description 66 permits custom control of image annotation and database storage. The data store description 66 makes sure that a given software application is properly defined for generating a valid DICOM-compatible image header with informational attributes for both display and storage with associated images. In particular, a means is provided by the data store description 66 that determines whether a given software application is properly defined for successfully connecting element-generating software components to all of the required image header building software components. In general, a valid DICOM image header includes all required type 1 and type 2 informational attributes or elements as dictated by DICOM standards. Software developers may add their own type 3 informational attributes or elements. In addition, a software developer may add new DICOM “private” informational attributes or elements which allow for custom image annotation and post processing. Lastly, the data store description 66 also allows control over the caching of images, whether they are stored in an image file in the database 44 or in an image file on the hard disk of the workstation computer 10.

As illustrated in FIGS. 3 and 5, after the prescription is completely entered and the scan descriptions 50 are completed, a download may then be initiated by the operator. Upon initiating download, the snap shot controller 54 operates to transfer software components in the scan descriptions 50 to the server computers 18, 20, 22, and 23. This is accomplished by forming agents 68, 70, 72, 74, and 76 from software components in the respective descriptions 58, 60, 62, 64, and 66. Each resulting agent includes a set of objects that can direct operation of a server computer to carry out specific tasks during a scan. To transfer downloadable software components to a server computer, an agent uses serialization indicated in process block 78 of FIG. 5. Serialization transforms the agent's objects into a stream format that maintains the name of the object class, the instances of their data, and the references between objects. When first initialized, the agent registers with the snap shot controller 54. When the prescription is complete, the snap shot controller 54 informs the agent that it is to take a snap shot. The agent serializes itself and all of its downloadable software components, then hands that data stream and the identity of the target server to a snap shot object. That snap shot object is passed to the target server to complete the download.

The serialization mechanism is a standard feature in Java™ which allows objects to be written to an output data stream as described, for example, in U.S. Pat. No. 6,092,120, issued on Jul. 18, 2000, and entitled “Method and Apparatus for Timely Delivery of a Byte Code and Serialized Object” which is incorporated herein by reference. The data stream can be passed across process boundaries, or saved to disk to retain the state of the objects for later use. The serialized object data stream carries the class name of each object and that object's instance data described by attribute name, type, and value. A powerful aspect of serialization is the ability to capture the relationships between objects when the data stream is received and deserialized. This allows a graph of objects to be captured in the serialized stream and then recreated at a later time or on a different machine. The serialization mechanism captures all relationships between objects. Each object in the graph is only serialized once. Should one object be referenced more than one time, the serialization mechanism recognizes the repeat and inserts a reference to the previous occurrence in the stream. This prevents endless loops during serialization and the potential for stream bloat due to duplication of objects. It is important to note that the serialized data stream only contains the object data and does not include object method code, the executable portion of the object. This substantially reduces the amount of data downloaded to the servers by the snap shot controller 54. It also requires that object method code be resident on each server computer.

As illustrated in FIG. 5, the serialized agents 68, 70, 72, 74, and 76 are downloaded to corresponding functional servers 80, 82, 84, 86, and 88. Functional servers 80, 82, 84, and 86 reside on the three server computers 18, 20, and 22, and the data is conveyed through an Ethernet serial communications network. The pulse server 80 and the sequence server 82 reside on the hardware of the pulse sequence server computer 18, the acquisition server 84 resides on the hardware of the data acquisition server computer 20, and the data process server 86 resides on the hardware of either server computer 20 or server computer 22. The data store server 88 resides on the workstation computer 10. It should be apparent to those skilled in the art that the functional servers may reside on many different hardware combinations and that the present architecture facilitates the use of different hardware combinations. If different server hardware is used, the agent is unchanged and only the server location changes. This allows, for example, simulation servers to run on a single processor rather than on separate processors when needed for performance reasons and certain desired performance goals.

The serialized agents are received by the corresponding target functional servers when a snap shot download event is generated by the snap shot controller 54. Each stream of serialized agents must be deserialized as indicated at process blocks 90 in FIG. 5. If the servers are written in Java™, this deserialization is a standard feature of the language as described, for example, in the above-cited U.S. Pat. No. 6,092,120. As indicated above, however, in a preferred embodiment, the servers employ C++ object code, and the deserialization requires some extra effort. To perform the deserialization, the servers use a C++ library for restoration of the Java™ object stream. This tool is able to parse the Java™ stream and present the contained class names, attributes, and object relationships to reader writer classes. Each C++ component that is to be created from the stream must have a reader writer. This class maps the parsed information to appropriate constructors and set methods of the C++ objects.

As stated previously, the serialized stream does not contain code, only instance data for the objects. The code for the C++ classes resides on the server. Every type of Java™ agent and Java™ downloadable software component has a mirror C++ object on the server. The mirrored components must have the same class name and share a common set of attributes. At the completion of the deserialization process, executable object code indicated at 92 resides in each of the functional servers 80, 82, 84, 86, and 88. Each functional server does the equivalent of signaling the snap shot controller 54 in the workstation 10 when the download is completed and the application state object 48 changes to the “downloaded” state.

When the operator activates the “run” button on the control panel, the scan controller 56 coordinates the run time operation of the workstation computer 10 and the server computers to perform the scan. To do this, the scan controller 56 may communicate with the functional servers 80, 82, 84, 86, and 88 across a number of different bus structures, backplanes, and serial communications networks. For example, the scan controller 56 signals the pulse sequence server computer 18 to start the scan, and it receives a notice from the data processing server computer 22 when images are available to store/view. In addition, the functional servers must communicate with each other during the scan. For example, the pulse server 80 and the sequence server 82 operate in close coordination using the corresponding downloaded agents to produce the desired pulses in the required sequence and with the required timing. The acquisition server 84 may send information back to servers 80 or 82 to alter a pulse or the sequence during the scan. MR raw data acquired by the acquisition server 84 is passed on to the data process server 86, which processes it to create image pixel data, and the data store server 88 receives information from both the data process server 86 and the workstation computer 10 to carry out its function of merging informational attributes including, for example, patient information together with reconstructed images produced by the medical imaging apparatus 140.

This run-time communications is provided by a tagged data transfer system. Tagged data transfer is a system that isolates applications/servers from hardware dependencies by providing tag (data packet) representation and routing mechanisms with different low-level communication schemes. A tagged data packet consists of a header and a payload. The header contains information useful for interpreting the payload such as ID, tagged data type, payload size, byte order, hop count, et cetera. The payload contains the platform independent data or tagged data object. The data being passed can be transferred and interpreted in-process or inter-process including processes distributed across different programmable machines.

Tagged Data:
Header
ID
Type
Payloadsize
ByteOrder
Payload

Tagged data objects are created by requesting a tagged data system singleton. The data to be transported is passed to the tagged data system in the form of a taggable. Data can be appended, removed, and updated in a tagged data object. Then the tagged data object is sent to a tag router, which takes care of sending the data to its destination. As illustrated in FIG. 4, the workstation computer 10 and each of the functional servers 80, 82, 84, 86, and 88 includes a tag router 94. These are written in Java™ and in C++, and they communicate with each other using the available communications hardware and protocols. Any process interested in receiving tagged data has a logical address which it registers with the local tag router. Such registration includes providing its reference. The reference contains information about the process/server ID, application ID, snap shot, and the agent/component ID. Each process thus has at least one tag router which enables tagged data transfer with other processes.

A tag router maintains data transfer channels which resemble stream pipes. These channels hide the low level communication details from the tag router and provide a mechanism to transport tagged data to its peer in another process space. A channel consists of an incoming data channel and an outgoing data channel. The in and out channels indicate a queuing/dequeuing scheme and communications schemes. A sending process has the option of getting notification upon the failure or success of the tag send operation. The sending process can also specify the queue size on incoming and outgoing channels.

The DICOM standard is used to represent data and hence achieve platform independence. The Digital Imaging and Communications in Medicine (DICOM) standard was developed by the American College of Radiology and the National Electrical Manufacturers Association to provide a standard for transferring medical images and associated information between devices. The data types in DICOM are well defined and are hardware independent. Predefined DICOM tags can be used to identify data that is being transmitted, and packets can be easily extended by software application programmers and developers.

The Java™-based infrastructure provided by the system architecture of the present invention facilitates changes in system hardware, changes in clinical applications, and the addition of new clinical procedures. The system software on the workstation computer is highly transportable from one program machine to another as long as both are configured to have Java™ virtual machines (JVMs). The server computers contain hardware dependent software programs that require changes when changes are made in the system hardware they control, but such changes are primarily limited to the server computers themselves and generally do not affect the workstation computer. In certain cases, it may be necessary to change the agent in the workstation computer that corresponds to a changed server, but this is a well-defined task that does not impact other aspects of workstation computer operation.

In general, any addition of a new clinical software application for execution and use on the medical imaging apparatus system 138 requires the corresponding addition of a new application container. The Java™-based infrastructure provides objects that perform the downloading and tag communications functions. The details of how these functions are performed over the particular system serial links and backplanes is transparent to the software application programmer or developer who can focus on defining the correct pulses, pulse sequence, and NMR data acquisition and processing functions for the new clinical software application.

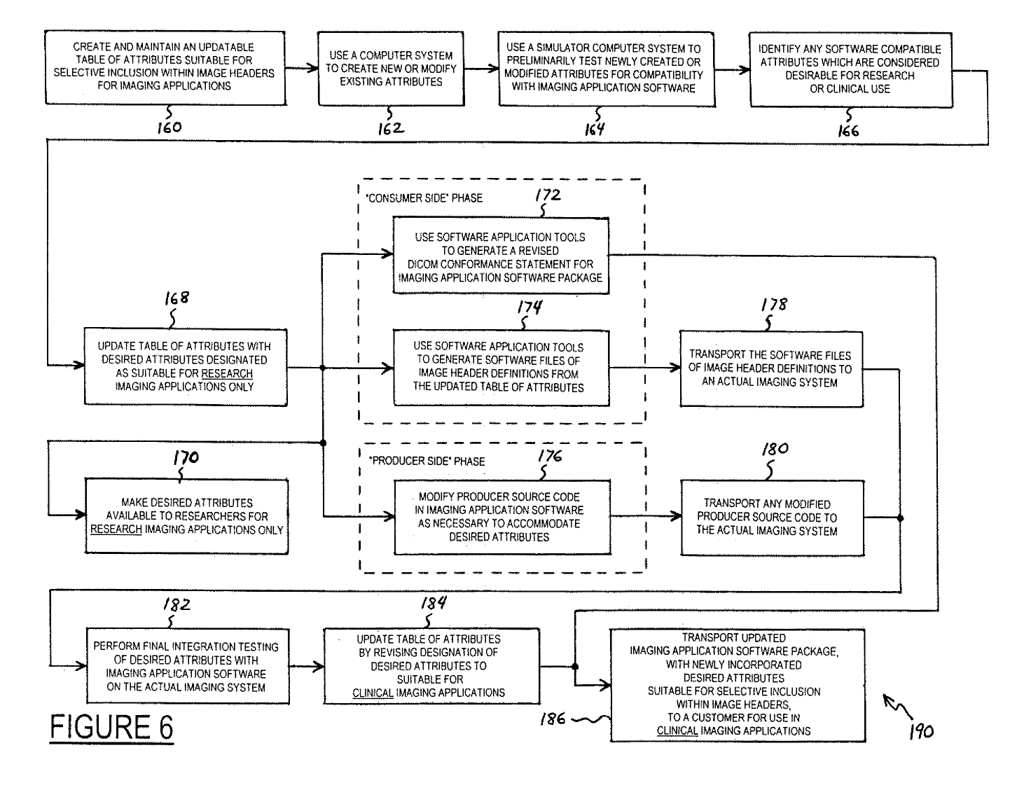

FIG. 6, as an example, is a flowchart of a method 190 for enabling a software developer to introduce new or modified informational attributes that are suitable for selective inclusion within image headers for medical imaging applications. As depicted, the method 190 generally includes the method steps 160, 162, 164, 166, 168, 170, 172, 174, 176, 178, 180, 182, 184, and 186. In general, the steps 160, 162, 164, and 166, first of all, may largely be performed by utilizing the developer-interactive simulation computer system 130 set forth in FIG. 2. The steps 168, 170, 172, 174, and 184, in turn, may at least be partially performed with the assistance of the developer-interactive computer 134, which has a memory-stored table of defined informational attributes, also set forth in FIG. 2. The steps 170, 178, 180, and 186, next of all, may be carried out, at least in part, with the assistance of the electrical communications network 132 set forth in FIG. 2. Finally, the step 182 may be performed with the assistance of the medical imaging apparatus system 136, which is designated for integration testing, also set forth in FIG. 2. With regard to FIG. 6, it is to be understood that the method 190 set forth therein is merely an example of a method that may potentially be selectively utilized for clinical medical imaging purposes. More particularly, both possible and permissible variations of and deviations from the method 190 specifically set forth in FIG. 6 are essentially innumerable pursuant to the present invention.

As briefly alluded to earlier hereinabove, in past medical imaging apparatus systems, in order to increase image header sizes and/or to enable software developers or operators to include new or modified informational attributes and even some “private” informational attributes within image headers, significant source code changes had to necessarily be made in the underlying system software architecture and/or operator-run software applications of the medical imaging apparatus system. The software development process in implementing such source code changes generally had two phases, the “producer side” phase and the “consumer side” phase. The producer side phase refers to the development of software that will help provide or produce the actual information or value for a particular newly proposed informational attribute. Thus, in order to facilitate the enabling of a software developer or operator to selectively add such an informational attribute to an image header, software source code that would help produce the value for that informational attribute first had to be written. The consumer side phase, on the other hand, refers to the development of software source code that helps “carry” or transport the produced value of the informational attribute to the image header by matching up and binding the produced value with its respective informational attribute name. In this consumer side phase, many steps including changing image header structure, rebuilding several processes, testing, and updating the DICOM translator and conformance statement had to be performed. In sum, therefore, software source code revision and development between the two phases in past medical imaging apparatus systems was necessarily highly coupled and interrelated. As an ultimate result, the whole software source code revision process was highly iterative, complex, time-consuming, and therefore often error prone.

In contrast to such past medical imaging apparatus systems requiring the laborious revising and troubleshooting of software source code, methodology pursuant to the present invention, as illustrated in FIG. 6, requires minimal to no source code writing revisions. In particular, in the “consumer side” phase, pre-existing software application tools are utilized pursuant to the present invention to automatically generate necessary software source code, computer software files (for example, XML files), and/or revised DICOM conformance statements as illustrated by steps 172 and 174 in FIG. 6. Thus, in the consumer side phase, virtually no new or revised software source code is required to be written. In the “producer side” phase, minimal to no new or revised producer software source code is required to be written as illustrated by the step 176 in FIG. 6. Depending on the situation, however, some minimal producer software source code may need to be written and downloaded onto the interactive workstation computers 10 and 10″ and/or the data store server computers 23 and 23″ in FIG. 2 to thereby tweak and accommodate the Java virtual machine supported on the workstation computers 10 and 10′. In view of such, therefore, it is important to note that the method 190, as summarily set forth in FIG. 6, should merely serve as an example, for various slightly different methodologies may also be alternatively adopted pursuant to the present invention.

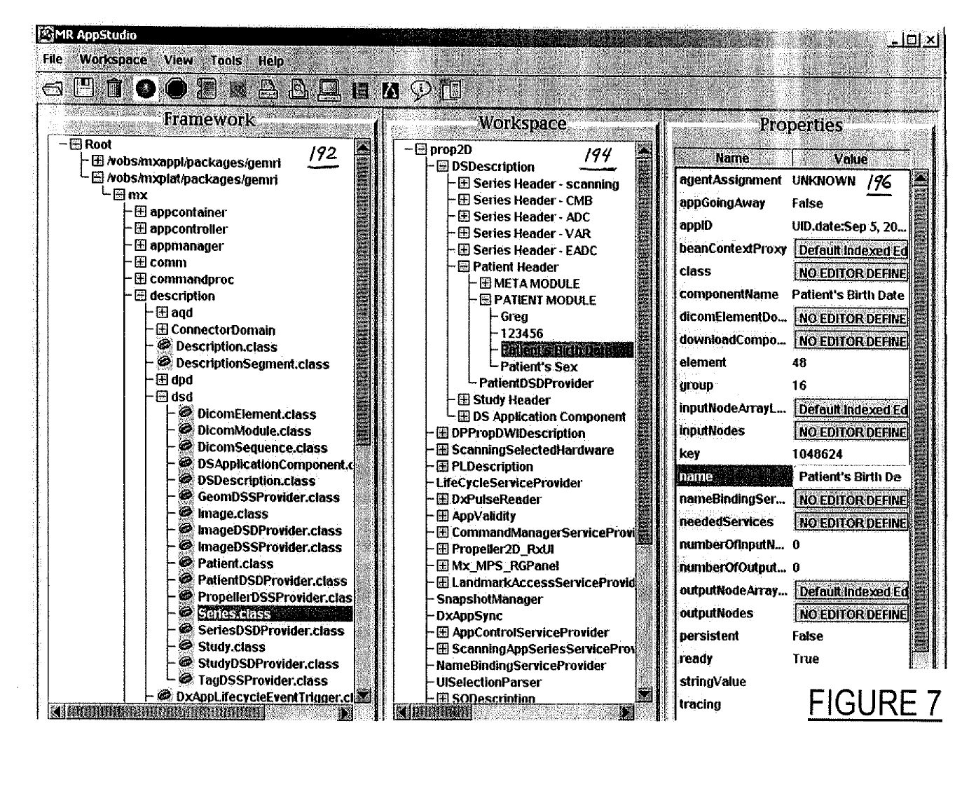

FIG. 7 is a screen view of the display monitor 142 associated with the developer-interactive simulation computer system 130 illustrated in FIG. 2. A first field 192 designated “framework”, a second field 194 designated “workspace,” and a third field 196 designated “properties”, all of which are associated with the graphical user interface (GUI) of the visually oriented application development software MRAppStudio™, are particularly depicted therein. In using such visually oriented application development software, a research or commercial software developer is able to utilize the pointing device 146 for performing both point-and-click and drag-and-drop operations on previously defined informational attributes and/or previously defined informational attribute components displayed on the screen of the display monitor 142 to thereby selectively create newly defined informational attributes and/or selectively modify previously defined informational attributes as desired for potential future use in actual medical imaging and scanning operations. In this way, a software developer is thereby able to quickly create and/or modify informational attributes as desired without having to laboriously write new or revised software source code.

In general, the first field 192, designated “framework” in FIG. 7, includes a listing (i.e., a “palette”) of a plurality of defined informational attributes, defined informational attribute components, elements, and/or objects that was previously derived at some point in time from the updatable table of defined informational attributes and defined informational attribute components memory-stored in the developer-interactive computer 134 in FIG. 2. The second field 194, designated “workspace” in FIG. 7, includes one or more selectable static design time containers (for example, pulse description PLD, sequence description SQD, acquisition description AQD, and data processing description DPD) and particularly includes the static design time container designated “data store description” (DSD). The third field 196, designated “properties” in FIG. 7, includes operative parameters that can be selectively set by a software developer for the purpose of newly creating and/or modifying one or more informational attributes.

Given such in FIG. 7, various drag-and-drop methods for introducing newly created and/or modified informational attributes that are suitable for selective inclusion within image headers may be formulated. In one example, one such drag-and-drop method generally includes, first of all, the steps of (a) providing a developer-interactive computer 134 having a memory-stored updatable table of defined informational attributes and defined informational attribute components suitable for selective inclusion within image headers, and (b) providing a developer-interactive computer system 130 having software suitable for creating and modifying defined informational attributes and also simulating application software driven operation of a medical imaging apparatus 140. In addition, the drag-and-drop method also includes the steps of (c) selecting a defined informational attribute or a defined informational attribute component from a palette set forth within a first field 192 delimited on the screen of the developer-interactive computer system 130, (d) moving the selected informational attribute or attribute component from the first field 192 and across the screen to a second field 194 delimited on the screen, (e) releasing the selected informational attribute or attribute component so that the selected informational attribute or attribute component remains situated in a static design time container (i.e., DSD) set forth within the second field 194 on the screen, and (f) repeating steps (c) through (e) until an aggregate of informational attribute components sufficient for newly creating or modifying at least one informational attribute remains situated in the static design time container within the second field 194. In further addition, the drag-and-drop method also includes the steps of (g) selectively setting operative parameters, in a third field 196 delimited on the screen, for the informational attribute components included in the aggregate for the purpose of newly creating or modifying at least one informational attribute, and (h) further using the third field 196 to selectively establish operative relationships (if any) between the informational attribute components included in the aggregate for the purpose of newly creating or modifying at least one informational attribute. Lastly, the drag-and-drop method also includes the steps of (i) utilizing the developer-interactive computer system 130 for simulating application software driven operation of the medical imaging apparatus 140 to thereby test each newly created or modified informational attribute for desirability and compatibility with application software, and (j) utilizing the developer-interactive computer 134 for selectively including each newly created or modified informational attribute in the table of defined informational attributes and defined informational attribute components suitable for selective inclusion within image headers to thereby update the table.

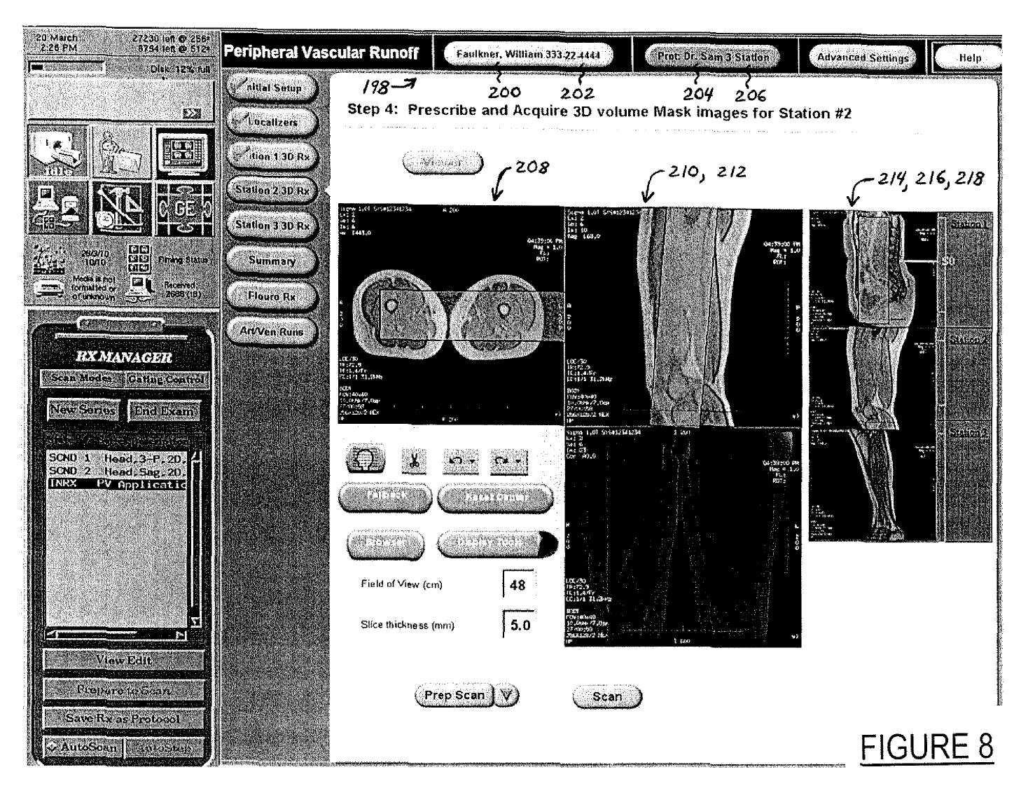

Once informational attributes approved for clinical use, whether they be new, modified, or old, are selectively grouped together (i.e., prescribed) by an operator and included within the static design time container DSD of a defined software application that is selectively executable on, for example, the workstation computer 10 of the medical imaging apparatus system 138 in FIG. 2, the data store description (DSD) is then downloaded to the data store server computer 23 upon activation of the medical imaging apparatus system 138 by the operator. As raw image data is produced by the medical imaging apparatus 140, acquired by the data acquisition server computer 20, processed by the data processing server computer 22 to produce image pixel data (as an example), and ultimately received and collected by the data store server computer 23, the informational attributes dictated by the downloaded DSD are then included within an image header generated by the data store server computer 23 and matched up with associated image pixel data in a DICOM-format image file also generated by the data store server computer 23. In addition, there are real-time informational attributes that are generated by the sequence agent 70 and data process agent 74 that are also passed on to the data store agent 76 during run time. Once such an image file is generated, the image header, along with its informational attributes, can then be selectively formatted and displayed together with one or more digital images, formed from the image pixel data, on the display monitor 12 and/or the floor monitor 42 as desired by the operator. FIG. 8, as an example, shows a screen view of the display monitor 12 associated with the operator-interactive workstation computer 10 included in the medical imaging apparatus system 138 of FIG. 2. As shown therein, the screen view includes, first of all, a top screen bar 198 with prescription information including, in particular, patient name 200, patient identification number 202, name of presiding medical professional 204, and medical imaging apparatus identification number 206. Such prescription information itself may, in certain situations, get downloaded to the data store server computer 23 to be put into an image header. In addition to the screen bar 198 and its prescription information, the screen view also includes multiple digital images 208, 210, 212, 214, 216, and 218 with strings of information (in white characters in FIG. 8) superimposed thereon which are formatted from information in image headers containing informational attributes. As depicted, the digital images show various sectional views of a patient scanned by the medical imaging apparatus 140. In addition to displaying the contents of such an image file on the display monitor 12 and/or the floor monitor 42, the operator may also selectively store the image file in the database 44 or even transport the image file to some remote destination device via the electrical communications network 132.

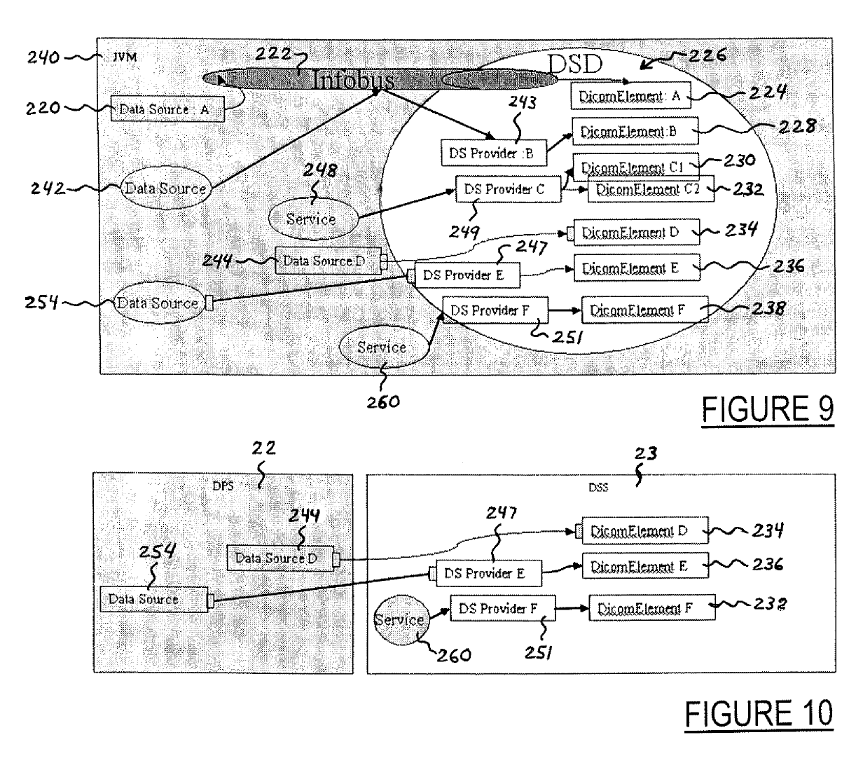

Again, as briefly alluded to earlier hereinabove, in the underlying system software and/or the application software development process, the producer side phase refers to the development of software that will help provide or produce the actual information or value for a particular newly proposed informational attribute. Thus, in order to facilitate the enabling of a software developer or operator to selectively add such an informational attribute to an image header, software source code components that help produce the value for that informational attribute are included in system software and/or application software pursuant to the present invention. In particular, brief routines of Java software source code (i.e., components) that operate to produce the value or “data item” for an informational attribute are provided and are software-registered as “producers” or “data sources.” The consumer side phase, on the other hand, refers to the development of software source code that helps “carry” or transport the produced value of the informational attribute to the image header by matching up and binding the produced value with its respective informational attribute name. Thus, pursuant to the present invention, brief routines of Java software source code (i.e., components) that operate to receive and obtain (i.e., “consume”) a produced value or data item from a data source are software-registered as “consumers.” DICOM elements associated with DICOM-formatted informational attributes are examples of such consumers. Given such, therefore, FIGS. 9 and 10 are diagrams that illustrate some of the various different ways in which actual information or values produced for selected informational attributes are matched up and bound together with their respective informational attribute names for ultimate inclusion within an image header.

In FIG. 9, for example, a data source “A” 220 produces a value or data item for an informational attribute named “A.” The Infobus 222, which is software supported on workstation computer 10 (and also 10′), serves to facilitate the data exchange of the data item from data source “A” 220 to DICOM element “A” 224. The DICOM element “A” 224 itself is associated with DICOM-formatted informational attribute “A” that had been selectively included (i.e., “dragged and dropped”) in the “data store description” (DSD) static design time container 226 by a developer or an operator for ultimate inclusion within an image header. Once the DICOM element “A” 224 receives the data item in this manner, the DICOM element “A” 224 along with the data item is communicated via the Java™ virtual machine (JVM) 240, software-supported on the workstation computer 10 (and also 10′), to the data store server (DSS) computer 23 (see FIG. 2) during serialization when the data store agent 76 (see FIG. 5) is downloaded. Once downloaded to the data store server computer 23, the DICOM element “A” 224 along with the data item is statically available to be included later in an image saved by the data store server computer 23, together with its associated image pixel data produced by the medical imaging apparatus 140, within a memory or database selectively prescribed by the operator. Thus, in this example, the data exchange of the data item from data source “A” 220 to DICOM element “A” 224 is performed during download before scanning operations actually commence.

In addition, DS provider “B” 243 is responsible for getting informational attribute “B” from Infobus 222 and thereafter transforming it into a DICOM format that DICOM element “B” 228 can accept. Informational attribute “B” comes from data source 242 via the Infobus 222 before download. The DS provider “B” 243 itself is not downloaded to the data store server computer 23 since its job is done during prescription time.

In further addition, DS provider “C” 249 is responsible for getting several informational attributes including “C1” and “C2” from a “service” object 248 in the Java™ virtual machine (JVM) 240. As was the case for “B” discussed in the previous paragraph, the job of the DS provider “C” 249 is finished during prescription—the final values are loaded into the data store server computer 23 when the data store agent 76 (see FIG. 5) is downloaded.

In FIGS. 9 and 10, data source “D” 244 resides in the data process agent 74 (see FIG. 5), and data will not be provided until scanning is started. Therefore, DICOM element “D” 234 in the data store agent 76 and the data source “D” 244 in the data process agent 74 and their connection will need to be downloaded. The value for informational attribute “D” is generated dynamically, data source “D” 244 to DICOM element “D” 234, while the medical imaging apparatus 140 is running, and informational attribute “D” will move between the data processing server computer 22 and the data store server computer 23.

Also, in FIGS. 9 and 10, informational attribute “E” is similar to informational attribute “D” except that there is a conversion operation between the value that the data processing server computer 22 provides and that the DICOM element “E” 236 requires. This conversion is done in the data store server computer 23 by DS provider “E” 247. Informational attribute “F”. in turn, is similar to informational attribute “E” except that the service 260 is already a part of the data store server computer 23 and needs to be transformed by the DS provider “F” 251 into the DICOM element “F” 238.

In general, therefore, as illustrated in FIGS. 9 and 10, the informational attributes associated with DICOM elements 224, 228, 230, 232, 234, 236, and 238 have all generally been selectively included by a developer or an operator in the data store description (DSD) 226 for ultimate inclusion within the same image header. As shown, informational attributes “A,” “B,” “C,” “C1,” “C2,” “D,” “E,” and “F” produced directly or indirectly by data sources 220, 242, 244, and 254 and also workstation computer-provided (i.e., “host”-provided) static or computational “services” 248 and 260 are provided to the DICOM elements 224, 228, 230, 232, 234, 236, and 238 via various different data exchange methods which may or may not be facilitated by the Infobus 222. In addition, individually produced values or data items for the informational attributes, depending on their individual inherent natures, may be derived indirectly from software application-prompted operator input on the keyboard 14 of the workstation computer 10.

Furthermore, in FIG. 10, data source “D” 244 in the data store server computer 23 downloaded via serialization from data source “D” 244 may produce a value or data item for informational attribute “D” and exchange the data item with DICOM element “D” 256 via direct tag transfer from the data processing server (DPS) computer 22 to the data store server (DSS) computer 23. In addition, the data source 254 associated with the data processing server (DPS) computer 22 may produce a value or data item for informational attribute “E” with the assistance of DS provider “E” 247 and send the data item via tag transfer to DICOM element “E” 236 in the data store server (DSS) computer 23. Lastly, given that some information, values, and/or data items to be included in certain informational attributes are static (i.e., unchanging) even under certain varying operating conditions and even for different software applications that are selected and executed by operators on the medical imaging apparatus system 138, the data store server (DSS) computer 23 itself in such cases will often automatically produce and provide the value or data item to the DICOM element as a service. Such an example is particularly illustrated in FIG. 10 by service 260, DS provider “F” 251, and DICOM element “F” 238.

While the present invention has been described in what is presently considered to be its most practical and preferred embodiment or implementation, it is to be understood that the invention is not to be limited to the disclosed embodiment. On the contrary, the present invention is intended to cover various modifications and equivalent arrangements included within the spirit and scope of the appended claims, which scope is to be accorded the broadest interpretation so as to encompass all such modifications and equivalent structures as is permitted under the law.

1. A system for introducing informational attributes suited for selective inclusion within image headers that are selectively storable in a database together with pixel data of associated images produced by an imaging apparatus, said system comprising:
an interactive workstation computer system electrically connectable to the database, electrically connectable to the imaging apparatus, and comprising memory-stored software applications for operating said imaging apparatus;
a memory-stored updatable table of defined informational attributes suited for selective inclusion within image headers;
an interactive computer for generating software files of image header definitions from said table of defined informational attributes; and
a means to transport said software files of image header definitions to said interactive workstation computer system.

2. A system according to claim 1, wherein said interactive workstation computer system is suited for executing said software applications to thereby deliver operation control signals to said imaging apparatus, acquire raw data of images produced by said imaging apparatus, process said raw data, read said software files of image header definitions, generate image headers that selectively include informational attributes as specified by said software files, display said image headers together with associated digital images indirectly produced by said imaging apparatus, and selectively store said image headers together with pixel data of said associated digital images in said database.

3. A system according to claim 2, wherein said interactive workstation computer system comprises software for supporting InfoBus data exchanges to thereby facilitate the selective inclusion of informational attributes within generated image headers.

4. A system according to claim 1, wherein said interactive workstation computer system comprises software for supporting a Java™ virtual machine.

5. A system according to claim 1, wherein said memory-stored software applications are written in an object-oriented programming language.

6. A system according to claim 1, wherein said interactive computer comprises software for selectively creating newly defined informational attributes and selectively modifying previously defined informational attributes to thereby update said table of defined informational attributes.

7. A system according to claim 1, wherein said interactive computer comprises spreadsheet application software for both updating and maintaining said table of defined informational attributes.

8. A system according to claim 1, wherein said interactive computer for generating software files of image header definitions comprises at least one software application tool.

9. A system according to claim 1, wherein said means to transport said software files of image header definitions comprises an electrical communications network, and wherein said electrical communications network includes at least one network selected from the group consisting of a local area network, a wide area network, an Ethernet-based network, and the Internet.

10. A system, according to claim 1, further comprising an interactive computer system comprising software for creating and modifying defined informational attributes and simulating application software driven operation of said imaging apparatus.

11. A system according to claim 10, wherein said interactive computer system is suited for selectively creating newly defined informational attributes, selectively modifying previously defined informational attributes, and simulating application software driven operation of said imaging apparatus to thereby test newly created and modified informational attributes for desirability and compatibility with application software.

12. A system according to claim 10, wherein said interactive computer and said interactive computer system are substantially integrated and coextensive with each other.

13. A system according to claim 10, wherein said interactive computer system comprises a processor, a display monitor, a keyboard, a pointing device, and visually oriented application development software.

14. A system according to claim 13, wherein said pointing device is suited for performing both point-and-click and drag-and-drop operations on the screen of said display monitor of said interactive computer system to thereby selectively create newly defined informational attributes and selectively modify previously defined informational attributes.

15. A system for introducing informational attributes suited for selective inclusion within image headers that are selectively storable in a database together with pixel data of associated images produced by an imaging apparatus, said system comprising:
a database for retaining image headers and pixel data of associated images for storage and selective retrieval; an imaging apparatus;
a server computer electrically connected to said database and suited for collecting pixel data of digital images, generating image headers, and storing said image headers together with said pixel data in said database;
a network of additional server computers electrically connected to said server computer, electrically connected to said imaging apparatus, and suited for delivering operation control signals to said imaging apparatus, acquiring raw data of images produced by said imaging apparatus, processing said raw data, and delivering pixel data associated with said raw data to said server computer;
an interactive workstation computer electrically connected to said server computer, electrically connected to said network of additional server computers, and comprising memory-stored software applications for operating said server computer, said network of additional server computers, and said imaging apparatus; a memory-stored updatable table of defined informational attributes suited for selective inclusion within image headers;
an interactive computer system comprising software for creating and modifying defined informational attributes and simulating application software driven operation of said imaging apparatus;
an interactive computer for generating software files of image header definitions from said table of defined informational attributes; and
a means to transport said software files of image header definitions to said interactive workstation computer;
wherein said interactive computer system selectively creates newly defined informational attributes, selectively modifies previously defined informational attributes, and simulates application software driven operation of said imaging apparatus to thereby test newly created and modified informational attributes for desirability and compatibility with application software;
wherein said interactive computer selectively includes said newly created and modified informational attributes in said table of defined informational attributes to thereby update said table; and
wherein said interactive workstation computer executes said software applications to deliver operation control signals to said imaging apparatus, acquires raw data of images produced by said imaging apparatus, processes said raw data, read said software files of image header definitions, generates image headers that selectively include informational attributes as specified by said software files, displays said image headers together with associated digital images indirectly produced by said imaging apparatus, and selectively stores said image headers together with pixel data of said associated digital images in said database.

16. A system according to claim 15, wherein said database comprises a storage medium selected from the group consisting of a magnetic tape, a magnetic disk, a magneto-optical disk, an optical disk, a floptical disk, a floppy disk, a Zip disk, a hard disk, a disk cartridge, a tape cassette, a compact disc, and a digital versatile disc.

17. A system according to claim 15, wherein said imaging apparatus is selected from the group consisting of a computerized tomography imaging apparatus, a magnetic resonance imaging apparatus, an ultrasound imaging apparatus, and an x-ray imaging apparatus.

18. A system according to claim 15, wherein said server computer and said interactive workstation computer are substantially integrated and coextensive with each other.

19. A system according to claim 18, wherein said network of additional server computers comprises direct memory access hardware interfaced with both said server computer and said interactive workstation computer as integrated.

20. A system according to claim 15, wherein said network of additional server computers comprises software for supporting a real time operating system.

21. A method for introducing informational attributes suited for selective inclusion within image headers that are selectively storable in a database together with pixel data of associated images produced by an imaging apparatus, said method comprising the steps of:
(a) generating software files of image header definitions from a memory-stored updatable table of defined informational attributes suited for selective inclusion within image headers; and
(b) transporting said software files of image header definitions to an interactive workstation computer system comprising memory-stored software applications for operating the imaging apparatus.

22. A method according to claim 21, said method further comprising the step of:
(c) utilizing said interactive workstation computer system to execute said software applications to thereby deliver operation control signals to said imaging apparatus, acquire raw data of images produced by said imaging apparatus, process said raw data, read said software files of image header definitions, generate image headers that selectively include informational attributes as specified by said software files, display said image headers together with associated digital images indirectly produced by said imaging apparatus, and selectively store said image headers together with pixel data of said associated digital images in the database.

23. A method for introducing informational attributes suited for selective inclusion within image headers that are selectively storable in a database together with pixel data of associated images produced by an imaging apparatus, said method comprising the steps of:
(a) utilizing software to selectively create newly defined informational attributes and selectively modify previously defined informational attributes to thereby update a memory-stored updatable table of defined informational attributes suited for selective inclusion within image headers;
(b) generating software files of image header definitions from said table of defined informational attributes; and
(c) transporting said software files of image header definitions to an interactive workstation computer system comprising memory-stored software applications for operating the imaging apparatus.

24. A method according to claim 23, said method further comprising the step of:
(d) utilizing said interactive workstation computer system to execute said software applications to thereby deliver operation control signals to said imaging apparatus, acquire raw data of images produced by said imaging apparatus, process said raw data, read said software files of image header definitions, generate image headers that selectively include informational attributes as specified by said software files, display said image headers together with associated digital images indirectly produced by said imaging apparatus, and selectively store said image headers together with pixel data of said associated digital images in the database.

25. A method for introducing informational attributes suited for selective inclusion within image headers that are selectively storable in a database together with pixel data of associated images produced by an imaging apparatus, said method comprising the steps of:
(a) utilizing software for creating and modifying defined informational attributes and simulating application software driven operation of the imaging apparatus to thereby selectively create newly defined informational attributes, selectively modify previously defined informational attributes, and simulate application software driven operation of said imaging apparatus to thereby test newly created and modified informational attributes for desirability and compatibility with application software; and
(b) selectively including said newly created and modified informational attributes in a memory-stored updatable table of defined informational attributes suited for selective inclusion within image headers.

26. A method according to claim 25, said method further comprising the steps of:
(c) generating software files of image header definitions from said table of defined informational attributes; and
(d) transporting said software files of image header definitions to an interactive workstation computer system comprising memory-stored software applications for operating said imaging apparatus.

27. A drag-and-drop method for introducing informational attributes suited for selective inclusion within image headers that are selectively storable in a database together with pixel data of associated images produced by an imaging apparatus, said method comprising the steps of:
(a) selecting a defined informational attribute or a defined informational attribute component from within a first field delimited on a screen of an interactive computer system comprising software for creating and modifying defined informational attributes and also simulating application software driven operation of the imaging apparatus;
(b) moving the selected informational attribute or attribute component from said first field and across said screen to a second field delimited on said screen;
(c) releasing said selected informational attribute or attribute component so that said selected informational attribute or attribute component remains situated within said second field on said screen;
(d) repeating steps (a) through (c) until an aggregate of informational attribute components sufficient for newly creating or modifying at least one informational attribute remains situated within said second field;
(e) selectively setting operative parameters for said informational attribute components included in said aggregate for the purpose of newly creating or modifying at least one informational attribute;
(f) utilizing said interactive computer system for simulating application software driven operation of said imaging apparatus to thereby test each newly created or modified informational attribute for desirability and compatibility with application software; and
(g) selectively including each newly created or modified informational attribute in a memory-stored updatable table of defined informational attributes and defined informational attribute components suited for selective inclusion within image headers.

28. A drag-and-drop method according to claim 27, wherein said first field includes at least one plurality of defined informational attributes or defined informational attribute components at least partially derived from said memory-stored updatable table of defined informational attributes and defined informational attribute components.

29. A drag-and-drop method according to claim 27, wherein said second field includes a static design time container for newly creating or modifying at least one informational attribute.

30. A drag-and-drop method according to claim 27, wherein said interactive computer system includes a processor, a display monitor, a keyboard, a pointing device, and visually oriented application development software, and wherein steps (a) through (c) are primarily accomplished by utilizing said pointing device.

31. A drag-and-drop method according to claim 27, said method further comprising the steps of:
(h) generating software files of image header definitions from said table of defined informational attributes and defined informational attribute components;
(i) transporting said software files of image header definitions to an interactive workstation computer system comprising memory-stored software applications for operating said imaging apparatus; and
(j) utilizing said interactive workstation computer system for executing said software applications to thereby deliver operation control signals to said imaging apparatus, acquire raw data of digital images produced by said imaging apparatus, process said raw data, read said software files of image header definitions, generate image headers that selectively include informational attributes as specified by said software files, display said image headers together with associated digital images indirectly produced by said imaging apparatus, and selectively store said image headers together with pixel data of said associated digital images in the database.
